(19) United States
(12) Patent Application Publication
(10) Pub. No.: US 2002/0097810 A1
(43) Pub. Date: Jul. 25, 2002

(54) Power control apparatus and power control method

(76) Inventor: Tetsuya Seki, Sendai (JP)

Correspondence Address: KATTEN MUCHIN ZAVIS ROSENMAN, 575 MADISON AVENUE, NEW YORK, NY, 10022-2585, US

(21) Appl. No.: 09/894,175

(22) Filed: Jun. 27, 2001

(30) Foreign Application Priority Data
Jan. 22, 2001 (JP) 2001-013058

(51) Int. Cl. H04L 27/04

(52) U.S. Cl. 375/295; 370/318

(57) ABSTRACT

The present invention relates to a transmitting unit of a base station using CDMA system, where a power control apparatus is provided which comprises a power control section and a power correcting section. The power correcting section is composed of a mask signal correcting section for correcting power control information about transmission on the basis of mask signals to output the corrected power control information, a phase rotation correcting section for correcting the corrected power control information on the basis of a decision signal to input the resultant corrected amplitude value to the power control section, and a symbol arrangement information arithmetic section for outputting symbol arrangement information based on each of the mask signals to the mask signal correcting section and the phase rotation correcting section. With this configuration, it is possible to reduce or cut the circuit scale, thus promoting an increase in user capacity.

### BACKGROUND OF THE INVENTION

(1) Field of the Invention

The present invention relates to, for example, in a transmitter employing a nine-point constellation (arrangement of nine symbol points) involving mask signals, a power control apparatus and power control method suitable for use in a power correcting circuit for transmission symbols after rotation of symbol phases.

(2) Description of the Related Art

In the recent years, the code division multiple access system (which will be referred to hereinafter as “CDMA”) has been used as a standard of radio communication systems applicable to mobile units or the like. A feature of this CDMA is not only accommodating a large number of subscribers but also providing excellent resistance to fading and interference and even offering high frequency efficiency.

In addition, a transmitting apparatus (transmitter) included in a base station or mobile station primary-modulates data through the use of QPSK (Quadrature Phase Shift Keying) modulation and upconverts the modulated data code-multiplexed to produce a radio frequency signal (which sometimes will be referred to hereinafter as an “RF signal”) which in turn, is transmitted toward the space. On the other hand, a receiving unit (receiver) included in the base station or mobile station receives the code-multiplexed RF signal to downconvert, inversely spread and QPSK-demodulate it so that the data is obtainable.

As well known, the QPSK (which sometimes implies QPSK modulation) signifies a modulation mode in which a transmission symbol is placed at one of four points to provide four symbol points. In a mobile communication system, in order to increase the user capacity, the data mapping points are increased up to nine points by masking (signifying decrease of a component value to zero) one side of a transmission symbol. A constellation where mapping is made on these nine points is called a “nine-point constellation”. The base station is made to primary-modulate data for one user through the use of the nine-point constellation and code-multiplex it to produce an RF signal to be transmitted.

Moreover, in this nine-point constellation, since a symbol point to be actually transmitted is rotated by ±45 degrees by a masking operation, an error occurs with respect to a power value of a transmission symbol. For this reason, the correction on an error of the transmission symbol power takes place accordingly.

FIG. 22 is an illustration of an essential part of a transmitting apparatus of a base station. As FIG. 22 shows, a base station 93 includes, in addition to a receiving unit 92 which receives an RF signal from a mobile station (MS) 10, a transmitting apparatus 90. This transmitting apparatus 90 is for multiplexing signals outputted from an ATM (Asynchronous Transfer Mode) network (not shown) for conversion into an RF signal. A description will be given hereinbelow of a transmission flow where much attention is focused on modulation points.

First of all, an ATM processing unit 90h performs ATM termination processing of voice data from, for example, a wire telephone, with the data termination-processed being developed into data to be transmitted, in a coder 90a.

In addition, the coder 90a produces mask signals with respect to the I axis and the Q axis. The mask signal(s) is a control signal signifying that the data on the I axis or Q axis is set at zero (representing that at least one component of a symbol point is masked). Each of these mask signals is inputted to a power control apparatus 90d which will be described later.

The coder 90a masks the mask signal according to symbol through the use of a predetermined algorithm. A manner to mask it according to symbol is that masking is made repeatedly at a constant symbol period. The mobile station 10 also seizes this algorithm. For example, in masking according to symbol, an algorithm 1 is used with respect to a channel 1, while an algorithm N (N: a natural number equal to or more than two) is taken for a channel N.

A rotation control unit 90i inputs symbol power, to be actually transmitted, to a power control/phase correction signal outputting unit 90b on the basis of a signal transmitted from the mobile station 10. With respect to data to be transmitted which is outputted from the coder 90a, in the power control/phase correction signal outputting unit 90b, a transmission format is produced according to user (user 1 to user N) and a power control signal of a signal to be transmitted is produced on the basis of a transmission symbol power value inputted from the rotation control unit 90i.

In addition, a transmission frame produced is processed in spectrum and rotated in phase in a spread processing/phase rotating unit (phase shifter) 90c, and the processed signal is corrected in power in the power control apparatus 90d. Still additionally, the power-corrected signal is code-multiplexed for the user 1 to the user N in a multiplexing unit 90e, and the code-multiplexed signal is converted into a transmission frequency in an RF unit 90f and then transmitted through a plurality of antennas 90g.

In this case, the base station 93 is made to send transmission data and data, identical thereto and rotated in phase, through the use of transmission diversity, while the mobile station 10 sends, of two kinds of data sent through that transmission diversity, a phase of one data showing a better receiving condition to the base station 93.

FIG. 23 is a block diagram showing the power control apparatus (power correction control circuit) 90d, and showing a flow of a signal for one user. In FIG. 23, the power control apparatus 90d receives, from the spread processing/phase rotating unit 90c, information (each having two bits) about symbol point arrangements on the I axis and the Q axis. In addition, it receives, from the power control/phase correction signal outputting unit 90b through the spread processing/phase rotating unit 90c, power control information and a phase rotation quantity (degree), and further receives, from the coder 90a, mask signals on the I axis and the Q axis. This phase rotation quantity is equally called phase rotation information, rotation quantity or rotation angle, and it will sometimes be referred to simply as a rotation quantity in the following description.

In addition, the power control apparatus 90d is for rotating the phase of a symbol to be transmitted and further for collectively controlling the transmission power thereof, and is composed of a power correcting section 100 and a power control section 200. A total correction value in this power control apparatus 90d is obtained through a combination of two types of correction: correction by masking and correction by phase rotation. In other words, the power control apparatus 90d accomplishes the correction on the basis of mask signals inputted from the coder 90a and a rotation quantity inputted from the power control/phase correction signal outputting unit 90b.

This mask signal realizes a nine-point constellation. This nine-point constellation eliminates the limitation in number of signals to be multiplexed, imposed in the case of four points to increase symbol points; therefore, a mobile communication system can cope with an increase in users. In the following description, the nine-point constellation covers both a modulation mode for realizing the nine-point constellation and arrangement of nine points.

In this configuration, data DI and DQ each having two bits are inputted from the left side of FIG. 23, and are phase-rotated in a phase shifter 101. Each of the phase-rotated data (data after phase rotation) DI and DQ is inputted to the power control section 200 and further to the power correcting section 100. To the power correcting section 100, there is inputted the data DI and DQ before the phase rotation.

Furthermore, the power control/phase correction signal outputting unit 90b (shown as ìframe generationî) is for receiving a transmission power control signal (TPC signal) to output a quantity of rotation.

In addition, the power correcting section 100 receives three kinds of information, symbols and a signal: power control information (power correction value of a symbol) from the power control/phase correction signal outputting unit 90b, a symbol before the phase rotation, a symbol after the phase rotation and an 8-bit select signal.

As one example, the power control information is designated at P. This information P is control information based on a power value (indicated in terms of dBm or the like) of a symbol before correction, and sometimes signifies a power value. In a case in which P is used as a power value, an amplitude value corresponding to this P is sometimes represented at A [V].

Moreover, with respect to a symbol before correction, to a selector 100c there are inputted corrected power control information corrected with a power ratio of −3 [dB] in a negative correction circuit 100a and corrected power control information corrected with a power ratio of +3 [dB] in a positive correction circuit 100b. In addition, to the selector 100c, there is inputted a symbol which does not undergo correction.

The −3[dB]-corrected power control information is information indicative of a power value of a symbol after correction and is designated at P−3. This information P−3 is used as control information, and sometimes used as a power value. Likewise, the +3[dB]-corrected power control information is information indicative of a power value of a symbol after correction and is denoted at P+3, and this information P+3 is used as control information, and sometimes used as a power value. These expression will be used in the same meaning in the following description.

Thus, the selector 100c selects one kind from information representative of the symbol power values P, P−3 and P+3 on the basis of a select signal, and puts the selected information in the power control section 200.

Following this, the symbol power value (one of P, P−3 and P+3) outputted from the selector 100c is invertedly switched to positive or negative in a positive/negative inverter 201 of the power control section 200. Each of the positive symbol power value (P, P−3, P+3) and the negative symbol power value (−P, −[P−3], −[P+3]) is inputted to an I-side selector 202a and further to a Q-side selector 202b. Moreover, the data DI and DQ outputted from the phase shifter 101 are properly controlled in power and outputted as I-side and Q-side transmission data.

If a symbol point is at the origin (0, 0), each of the I-side selector 202a and the Q-side selector 202b sets the transmission symbol power at zero.

FIG. 24 is an illustration for explaining a nine-point constellation. In the case of this nine-point constellation shown in FIG. 24, in a constellation for QPSK modulation or the like, of each symbol (Xi, Yj), one component Xi or Yj (each of i and j represents a natural number) is masked, and in addition to the origin, eight symbol points are present. In this case, the masking signifies that a data value is set at zero.

Furthermore, in order to establish excellent communications between the base station 93 and the mobile station 10 (see FIG. 22), in addition to the ordinary constellation, each symbol is phase-rotated by a predetermined degree before being transmitted. In addition, a quantity of rotation to be inputted to the power control apparatus 90d is included in an FBI bit (FeedBack Information) transmitted from the mobile station 10 to the base station 93.

FIGS. 25A and 25B are illustrations for explaining that a quantity of rotation is obtainable in the base station 93. First, in FIG. 25A, the base station (BTS: Base Transceiver Station) 93 sends a data sample to the mobile station 10 through the use of transmission diversity. That is, during the communications between the base station 93 and the mobile station 10, the base station 93 sends transmission data and data identical thereto and rotated in phase, through a plurality of antennas (not shown) to the mobile station 10.

The mobile station 10 determines a better one of two kinds of rotation quantities transmitted, and informs the base station 93 of the determined rotation quantity with the FBI bit (see FIG. 25B). The base station 93 is made to determine a rotation quantity on the basis of a value indicated by the FBI bit. Incidentally, a detail of determining that rotation quantity is normalized.

Secondly, a further description will be given hereinbelow of the aforesaid symbol power control with reference to FIGS. 26 to 29.

The symbol power is made to be corrected on the nine-point constellation and phase rotation with respect to the I axis and the Q axis. The reason for the symbol power correction (which will be referred to hereinafter as ìpower correctionî) is to prevent the occurrence of an RF signal having high power instantaneously at multiple access communications. The prevention of the occurrence of an RF signal having instantaneous high power enables the system to increase the number of signals to be multiplexed in one RF circuit, thus enhancing the system subscriber capacity.

FIG. 26 is an illustration for explaining an arrangement of symbols after phase rotation. In FIG. 26, let it be assumed that a symbol 1 (Xi, Yj) is a symbol point before phase rotation. In this assumption, when the symbol 1 (Xi, Yj) undergoes rotation of 45 [degree], 135 [degree], 215 [degree] and 315 [degree], the symbol 1 (Xi, Yj) reaches symbols 2 (0, Yj), 3 (−Xi, 0), 4 (0, −Yi) and 5 (Xi, 0). In the following description, let it be assumed that the counterclockwise rotation is a positive phase rotation while the clockwise rotation is a negative phase rotation.

Meanwhile, the transmission symbol power requires a correction of +3 [dB] or −3 [dB]. FIG. 27 is an illustration for explaining the power correction at the phase rotation. In FIG. 27, the amplitude of the symbol 1 (Xi, Yj) signifies a distance A between (0, 0) and (Xi, Yj). When this symbol 1 makes no rotation of 45 [degree], the transmission symbol power becomes A×A+A×A=2·(A ×A), where “·” is an arithmetic symbol representing a multiplication. In the transmission symbol power control, the transmission is made at a transmission symbol power value of 2·(A×A) and, therefore, the amplitude value is recognized as A.

On the other hand, when the symbol 1 shown in FIG. 27 is rotated up to the point of the symbol 2 (0, Yj), that transmission symbol power becomes (A×A). Accordingly, the symbol 1 having the intended power value of 2·(A×A) results in being transmitted as the symbol 2 with power of (A×A), which halves the power. That is, an error of −3 [dB] occurs.

Likewise, in the case of the rotation from the symbol 4 (0, −Yj) to the symbol 6 (Xi, −Yj), the symbol 4 only having the intended power of (A×A) is transmitted as the symbol 6 with power of 2·(A×A), which induces the occurrence of an error of +3 [dB].

Accordingly, the following cases (1-1) and (1-2) require correction.

(1-1) Shift (rotation) of a symbol point before phase rotation by 45, 135, 215 and 315 [degree] from a state where it does not exist on the I axis or the Q axis (which will sometimes be referred to hereinafter as “out-of-axis position”. In this case, a correction with respect to +3 [dB] becomes necessary.

(1-2) Shift of a symbol point before phase rotation by 45, 135, 215 and 315 [degree] from the on-axis position. In this case, a correction with respect to −3 [dB] becomes necessary.

For example, a circuit for making the correction with respect to ±3 [dB] is as shown in FIG. 28.

FIG. 28 is an illustration for explaining a power correcting circuit employable for phase rotation. As FIG. 28 shows, the power control apparatus 90d receives 4-bit before-rotation symbol point arrangement information from the coder 90a and 4-bit after-rotation symbol point arrangement information from the spread processing/phase rotating unit 90c. The power correcting section 100 (the selector 100c, the negative correction circuit 100a and the positive correction circuit 100b in FIG. 23) performs the power correction on the basis of the inputted 8-bit information.

FIGS. 29A to 29C are illustrations for explaining power value correction. In FIG. 29A, in a case in which data to be transmitted in a symbol time period (time period) T1 corresponds to the symbol 1 shown in FIG. 27 and is phase-rotated in a time period T2 to produce the symbol 2, the magnitude of the amplitude in the time period T1 becomes 1/root 2 of the amplitude to be actually transmitted, and for example, is expressed by A′ as shown in FIG. 29B. Moreover, the amplitude in a transmission state is set at A in the time period T2 as shown in FIG. 29C.

Likewise, in FIG. 29A, data to be transmitted in a symbol time period (time period) T3 corresponds to the symbol 4 shown in FIG. 27, and is phase-rotated in a time period T4 to become the symbol 6. Still additionally, the amplitude is still A, which represents a magnitude at the out-of-axis position, in the time period T3 in FIG. 29B, while the amplitude in a transmission state is set at A′ in the time period T4 as shown in FIG. 29C.

However, in the foregoing power control apparatus 90d (see FIGS. 23 and 28), the data DI and DQ require four bits in total, and both the states before and after the rotation assume nine states (four bits). Thus, for both the symbols and states, the power correcting section 100c requires eight bits per user when maintaining the symbol states. Accordingly, the use of as many power control apparatuses as are needed for N users causes the enlargement of circuit scale.

### SUMMARY OF THE INVENTION

The present invention has been developed with a view to eliminating this problem, and it is therefore an object of the present invention to provide a power control apparatus and power control method capable of, in a transmitter of a base station of a radio communication system employing the CDMA method, reducing the circuit scale for promoting the increase in user capacity.

For this purpose, in accordance with the present invention, there is provided a power control apparatus comprising a power control section for controlling amplitude by correcting a symbol point arrangement of data on the basis of a correction amplitude value inputted from the external and for outputting data to be transmitted, produced by the amplitude control, and a power correcting section for correcting an amplitude value of a symbol before phase rotation on the basis of a decision signal representative of need/non-need for correction of the amplitude value of the symbol before the phase rotation and a mask signal (each of mask signals) indicative of that at least one of symbol point components is masked and for inputting the corrected amplitude value to the power control section.

Thus, when there is a need for power correction, 2-bit processing can be conducted with an effective signal of a mask signal, which enables simplifying the circuit scale.

In this case, it is also appropriate that the power control section and the power correcting section receive data modulated through the use of a nine-point constellation. This permits an increase in user capacity, for example, in the CDMA method.

In addition, it is also appropriate that the power correcting section is made to output the corrected amplitude value in units of 45 degree according to symbol. This enables transmission/reception of a symbol point arrangement to be accomplished with only 2-bit information.

Still additionally, it is also possible that the power correcting section comprises a mask signal correcting section for correcting power control information on transmission on the basis of a mask signal to output the corrected power control information, and a phase rotation correcting section for correcting the corrected power control information outputted from the mask signal correcting section on the basis of a decision signal and for inputting the corrected amplitude value to the power control section.

This enables a decrease in number of control bits needed for the power correction in the power correcting section, thereby cutting down the circuit scale.

Moreover, it is also appropriate that the mask signal correcting section comprises an arithmetic section for performing predetermined arithmetic processing on power control information to output the arithmetically processed power control information and a selecting section for outputting, as the corrected amplitude value, desired one of the power control information and the arithmetically processed power control information outputted from the arithmetic section on the basis of a mask signal.

In this way, the necessary amplitude value is realizable with a simple selection circuit, which contributes to a reduction of the circuit scale.

Still moreover, it is also appropriate that the phase rotation correcting section comprises an arithmetic section for performing predetermined arithmetic processing on the corrected power control information to output the arithmetically processed corrected power control information and a selecting section for outputting, as the corrected amplitude value, desired one of the corrected power control information and the arithmetically processed corrected power control information outputted from the arithmetic section on the basis of a decision signal and a mask signal. In this way, the number of bits to be inputted decreases so that the circuit scale is considerably reducible in view of a plurality of users.

Furthermore, it is also appropriate that the power correcting section comprises an arithmetic section for performing predetermined arithmetic processing on power control information to output the arithmetically processed power control information and a selecting section for outputting, as the corrected amplitude value, desired one of the power control information and the arithmetically processed power control information outputted from the arithmetic section on the basis of a decision signal and a mask signal. This enables a correction of the value of power control information outputted from the spread processing/phase rotating unit.

Still furthermore, it is also possible that the arithmetic section is designed to output, as the arithmetically processed power control information, subtracted power control information obtained by subtracting a predetermined value from power control information, or that the arithmetic section is made to output, as the arithmetically processed power control information, added power control information obtained by adding a predetermined value to the power control information.

In this case, design is achievable with a simple logic circuit.

In addition, it is also appropriate that a symbol arrangement information arithmetic section is further provided to output symbol arrangement information based on logic of a mask signal to the selecting section. With this further provision, the logic on the I axis or the Q axis agrees with the logic of an element, which cuts down the circuit scale.

Still additionally, it is also appropriate that a transmission symbol power adjusting section is further provided to adjust transmission symbol power on the basis of the corrected amplitude value outputted from the power correcting section. With this further provision, not only wireless transmission but also wire transmission are feasible.

Moreover, in accordance with the present invention, there is provided a power control apparatus comprising a power control section for conducting amplitude adjustment by adjusting a symbol point arrangement of data on the basis of an adjustment amplitude value inputted from the external and for outputting the data being transmitted, produced by the amplitude adjustment, and a power adjusting section for adjusting an amplitude value of a symbol before phase shift on the basis of a decision signal representative of need/non-need for adjustment of the symbol amplitude value before the phase shift and a mask signal representative of a phase shifted position stemming from a symbol point component and for inputting the adjusted amplitude value to the power control section. With this configuration, various modulation methods are acceptable.

Furthermore, in accordance with the present invention, there is provided a power control method comprising a phase rotating step of phase-rotating data placed at a symbol point (each of symbol points) through the use of a desired modulation method to output data to be transmitted, a mask signal outputting step of outputting a mask signal representative of that at least one of symbol point components is masked, an arithmetically processed power control information generating step of conducting predetermined arithmetic processing on power control information about transmission to generate corrected power control information, selecting/outputting step of selectively outputting desired one of the power control information and the arithmetically processed power control information generated in the arithmetically processed power control information generating step on the basis of the mask signal outputted in the mask signal outputting step and a decision signal representative of need/non-need for correction of an amplitude value of a symbol before phase rotation, and an amplitude controlling step of controlling an amplitude of the data to be transmitted, outputted in the phase rotating step on the basis of the power control information or the corrected power control information selectively outputted in the selecting/outputting step.

With this power control method, the transmission symbol power is adjusted after the phase rotation of a symbol, which contributes to a reduction of the circuit scale.

In this case, it is also possible that the phase rotating step is made to use a nine-point constellation. This enables an increase in user capacity through the use of, for example, the CDMA method.

In addition, in accordance with the present invention, there is provided a power control method comprising a phase rotating step of phase-rotating data placed at a symbol point through the use of a desired modulation method to output data to be transmitted, a corrected power control information outputting step in which a power correcting section having a desired correction quantity for each of the symbol points corrects power control information on the basis of a decision signal representative of need/non-need of an amplitude value of the symbol before phase rotation to output the corrected power control information, and an amplitude controlling step of controlling an amplitude of the data to be transmitted, outputted in the phase rotating step on the basis of the corrected power control information outputted in the corrected power control information outputting step.

In this arrangement, the power correcting section can seize the need/non-need for correction on the basis of a decision signal with a small data volume according to symbol, and because of a decrease in number of control bits, the power correcting section can cut down the circuit scale.

Still additionally, in accordance with the present invention, there is provided a power control method comprising a constellation correcting step of correcting data placed at a symbol point (each of symbol points) through a desired modulation method on the basis of a mask signal representative of at least one of symbol point components being masked, for outputting the corrected data, and a phase rotation correcting step of correcting the corrected data obtained in the constellation correcting step on the basis of a decision signal representative of need/non-need of an amplitude of a symbol before phase rotation for outputting total corrected data.

With this arrangement, it is possible to decrease the number of bits to be inputted to the power correcting section, which enables a considerable reduction of the circuit scale.

### BRIEF DESCRIPTION OF THE DRAWINGS

FIG. 1 is a schematic illustration of a configuration of a mobile communication system according to a first embodiment of the present invention;

FIG. 2 is an illustration of an essential part of a transmitter of a base station according to the first embodiment of the invention;

FIG. 3 is a block diagram showing a power control apparatus according to the first embodiment of the invention;

FIG. 4 is a schematic illustration of a configuration for power correction at phase rotation according to the first embodiment of the invention;

FIG. 5 is an illustration of a symbol point arrangement of a four-point constellation;

FIG. 6 is an illustration of a nine-point constellation in the case of an ordinary QPSK;

FIGS. 7A and 7B are illustrations of phase rotation information according to the first embodiment of the invention;

FIG. 8 is an illustration useful for explaining power correction in a power correcting section according to the first embodiment of the invention;

FIG. 9 is a block diagram showing a power control apparatus according to a first modification of the first embodiment of the invention;

FIG. 10 is an illustration useful for explaining a total correction value in the power control apparatus according to the first modification of the first embodiment of the invention;

FIGS. 11A to 11D are illustrations useful for explaining symbol states according to the first modification of the first embodiment of the invention;

FIG. 12 is a block diagram showing a power control apparatus according to a second modification of the first embodiment of the invention;

FIG. 13 is an illustration of a symbol point arrangement of a nine-point constellation in the case of 45-degree shifted QPSK;

FIG. 14 is an illustration useful for explaining power correction in a power correcting section according to the second modification of the first embodiment of the invention;

FIG. 15 is a block diagram showing a power control apparatus according to a third modification of the first embodiment of the invention;

FIG. 16 is an illustration useful for explaining a total correction value in the power control apparatus according to the third modification of the first embodiment of the invention;

FIGS. 17A to 17D are illustrations useful for explaining symbol states according to the third modification of the first embodiment of the invention;

FIG. 18 is a block diagram showing a power control apparatus according to a fourth modification of the first embodiment of the invention;

FIG. 19 is a block diagram showing another power control apparatus according to the fourth modification of the first embodiment of the invention;

FIG. 20 is a block diagram showing a power control apparatus according to a second embodiment of the invention;

FIG. 21 is a block diagram showing a power control apparatus according to a third embodiment of the invention;

FIG. 22 is an illustration of an essential part of a transmitter of a base station;

FIG. 23 is a block diagram showing a power control apparatus;

FIG. 24 is an illustration for explaining a nine-point constellation;

FIGS. 25A and 25B are illustrations for explaining the acquisition of a quantity of rotation in a base station;

FIG. 26 is an illustration for explaining a symbol arrangement after phase rotation;

FIG. 27 is an illustration for explaining power correction at phase rotation;

FIG. 28 is an illustration for explaining a power correcting circuit for phase rotation; and

FIGS. 29A to 29C are illustrations for explaining correction of a power value.

### DESCRIPTION OF THE PREFERRED EMBODIMENTS

Embodiments of the present invention will be described hereinbelow with reference to the drawings.

(A) Description of First Embodiment of the Invention

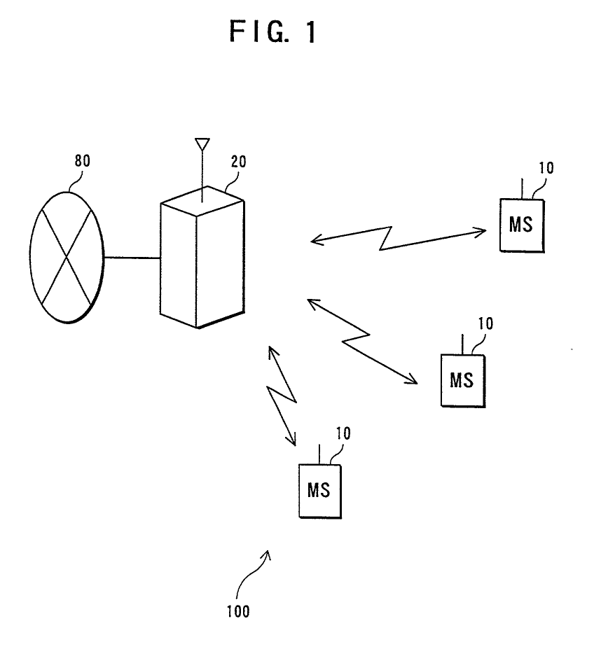

FIG. 1 is a schematic illustration of a configuration of a mobile communication system according to a first embodiment of the present invention. As FIG. 1 shows, the mobile communication system (which sometimes will be referred to hereinafter as ìsystemî), designated generally at 100, is made up of an ATM network 80, a base station 20 and a plurality of mobile stations (MS) 10. The base station 20 makes radio communications with each of the mobile stations 10, and receives a signal from the mobile station 10 to demodulate the received signal and output it to the ATM network 80, while converting a multiplexed ATM signal on each user, outputted from the ATM network 80, into an RF signal and sending it to the mobile station 10. In addition, unless otherwise specified particularly, the system 100 shown in FIG. 1 is also applicable to each modification of the first embodiment, a second embodiment, a third embodiment and a fourth embodiment (which sometimes will be referred to hereinafter as “other embodiments”) which will be described later.

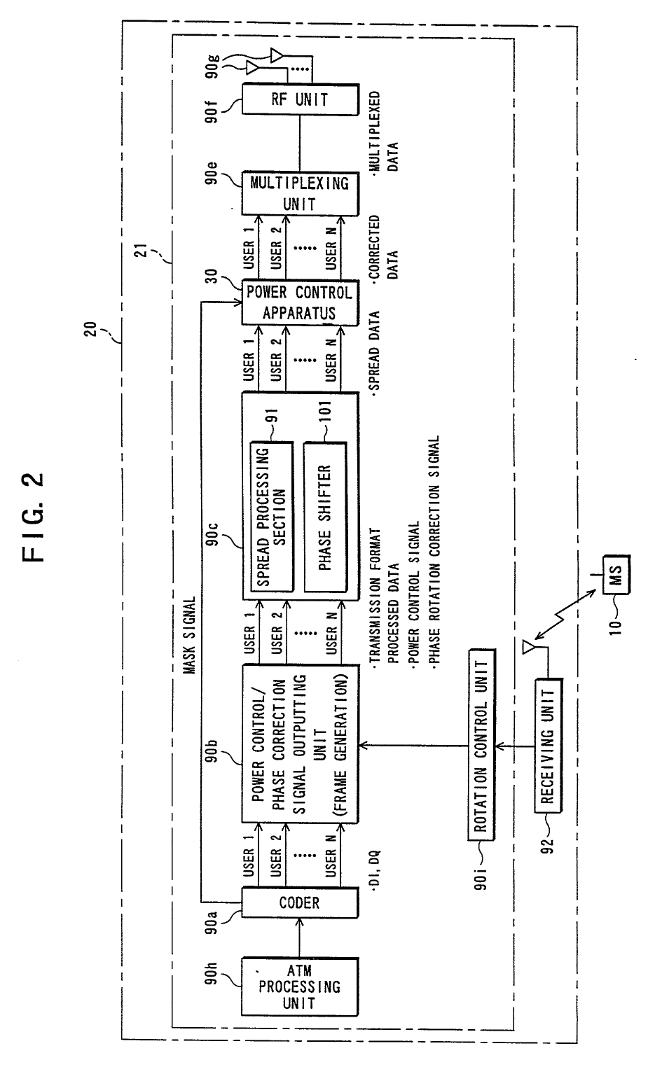

Now, when attention is focused on a transmission flow from the base station 20 to the mobile stations 10, the system configuration is as shown in FIG. 2.

FIG. 2 is an illustration of an essential part of a transmitter of the base station 20 according to the first embodiment of the present invention. As FIG. 2 shows, the base station 20 includes, in addition to a receiving unit 92 for receiving an RF signal from the mobile stations (MS) 10, a transmitting apparatus 21 which is for multiplexing signals outputted from the ATM network 80 and converting them into an RF signal. This transmitting apparatus 21 is composed of an ATM processing unit 90h, a coder 90a, a power control/phase correction signal outputting unit 90b, a spread processing/phase rotating unit 90c, a power control apparatus 30, a multiplexing unit 90e, an RF unit 90f, antennas 90g and a rotation control unit 90i.

The ATM processing unit 90h is for receiving a signal (ATM signal) stacked through the use of an ATM protocol to perform format conversion of this ATM signal. Concretely, the ATM processing unit 90h terminates ATM data outputted from the ATM network 80 and outputs it as, for example, a multiplexed voice signal in a wire telephone system.

The coder 90a is for converting a multiplexed voice signal outputted from the ATM processing unit 90h into data DI and DQ according to user, and further for generating mask signals with respect to an I axis and a Q axis to put them in the power control/phase correction signal outputting unit 90b. The mask signal is a control signal representative of that data on the I axis or Q axis is set at zero (indicative of that at least one of symbol point components is masked). For example, the mask signal with respect to each of the I axis and Q axis is set at ì0 î in the case of masking while being set at ì1î for non-masking. Incidentally, the reverse of this logic is also acceptable.

FIG. 5 is an illustration of a symbol point arrangement of a four-point constellation which is employed in a case in which data is transmitted unless masked at one side. In this case, when one sides of the components (Xi, Yj) of four symbol points are masked, the respective symbol point components are projected onto the axes, thereby realizing a nine-point constellation.

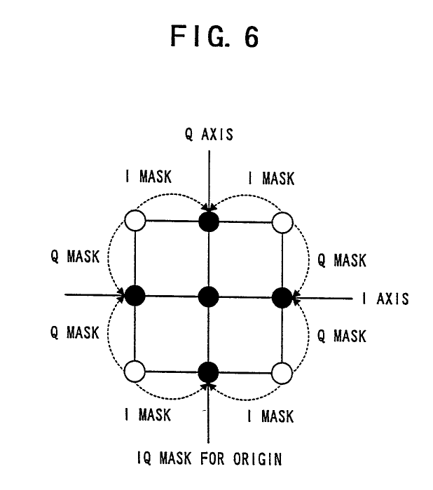

FIG. 6 is an illustration of a nine-point constellation for ordinary QPSK. That is, the presence of a symbol on the I axis and Q axis signifies that any one of the I-axis and Q-axis components is in a masked condition.

Thus, since whether a symbol before rotation is on an axis or out of an axis is sufficiently seizable by only information indicative of which of the I-axis and Q-axis components is masked, this information is expressed with one bit. In addition, this information is inputted as a mask signal(s) from the coder 90a to the power control apparatus 30.

Moreover, in connection with this mask signal, the coder 90a (see FIG. 2) is designed to make masking according to symbol in accordance with a predetermined algorithm. The base station 20 and the mobile stations 10 has the same masking algorithm (signifying which of the I-axis and Q-axis sides is masked). Accordingly, in the mobile stations 10, data masked in the base station 20 can be demodulated in accordance with that algorithm so that the correct data is obtainable. In this case, an algorithm 1 is used for a channel 1 and an algorithm N (N: a natural number equal to or more than two) is for a channel N.

Furthermore, the power control/phase correction signal outputting unit (frame generating section) 90b is for generating a power control signal (transmission symbol power control signal) and a phase rotation correction signal (phase rotation control information) and further for generating a transmission frame with respect to each user. In addition, this power control/phase correction signal outputting unit 90b is made to receive a power control signal and a phase rotation correction signal from the rotation control unit 90i. That is, for data outputted from the coder 90a, a transmission format is generated according to user (user 1 to user N), and a power control signal of a transmission signal is generated on the basis of a symbol power value inputted from the rotation control unit 90i.

The spread processing/phase rotating unit 90c is for spreading (spectrum-spreading) data formatted according to user and outputted from the power control/phase correction signal outputting unit 90b to make phase rotation, and is composed of a spread processing section 91 for conducting spread processing and a phase shifter 101. The symbol point arrangement to be actually transmitted is determined in this spread processing/phase rotating unit 90c.

The power control apparatus 30 is for performing power control or power correction on the spread data for each user outputted from the spread processing/phase rotating unit 90c, which will be described in detail hereinafter.

The multiplexing unit 90e is for multiplexing masked data for each user outputted from the power control apparatus 30, and the RF unit 90f is for frequency-converting the multiplexed data outputted from the multiplexing unit 90e into an RF signal. The antennas 90g are for transmitting the RF signal outputted from the RF unit 90f. In this case, because of the transmission diversity, the base station 20 has two or more antennas 90g to transmit transmission data and data identical thereto and phase-rotated.

On the other hand, each of the mobile stations 10 is made to transmit, of two kinds of data undergoing transmission diversity, the phase of one showing a better reception condition to the base station 20. For example, when the base station 20 transmits both data which is not phase-rotated and data which is phase-rotated by 45 degrees, if the mobile station 10 receives the 45-degree rotated data more satisfactorily, the mobile station 10 transmits information indicative of the 45-degree rotated data to the base station 20.

The receiving unit 92 receives an RF signal transmitted from the mobile station 10 and inputs a quantity of rotation to the rotation control unit 90i.

In addition, the rotation control unit 90i inputs a symbol power value to be actually transmitted to the aforesaid power control/phase correction signal outputting unit 90b on the basis of the RF signal transmitted from the mobile station 10.

Accordingly, a voice signal from, for example, a wire telephone system is ATM-terminated in the ATM processing unit 90h, with the terminated data being translated into data DI and DQ to be transmitted in the coder 90a. In addition, in the coder 90a, a mask signal with respect to each of the I-axis and Q-axis is generated and is inputted to the power control apparatus 30. Still additionally, a transmission frame generated is spread and phase-rotated in the spread processing/phase rotating unit 90c, and the processed signal is power-corrected in the power control apparatus 30 and code-multiplexed for each of the user 1 to the user N in the multiplexing unit 90e, with the code-multiplexed transmission signal being converted into a transmission frequency in the RF unit 90f and then transmitted through the plurality of antennas 90g.

In this connection, unless otherwise specified particularly, the configuration shown in FIG. 2 also applies to other embodiments and modifications which will be described later.

In the transmission from the base station 20 to the mobile stations 10, since the power correction takes place according to symbol as described above, the reduction of power consumption becomes feasible.

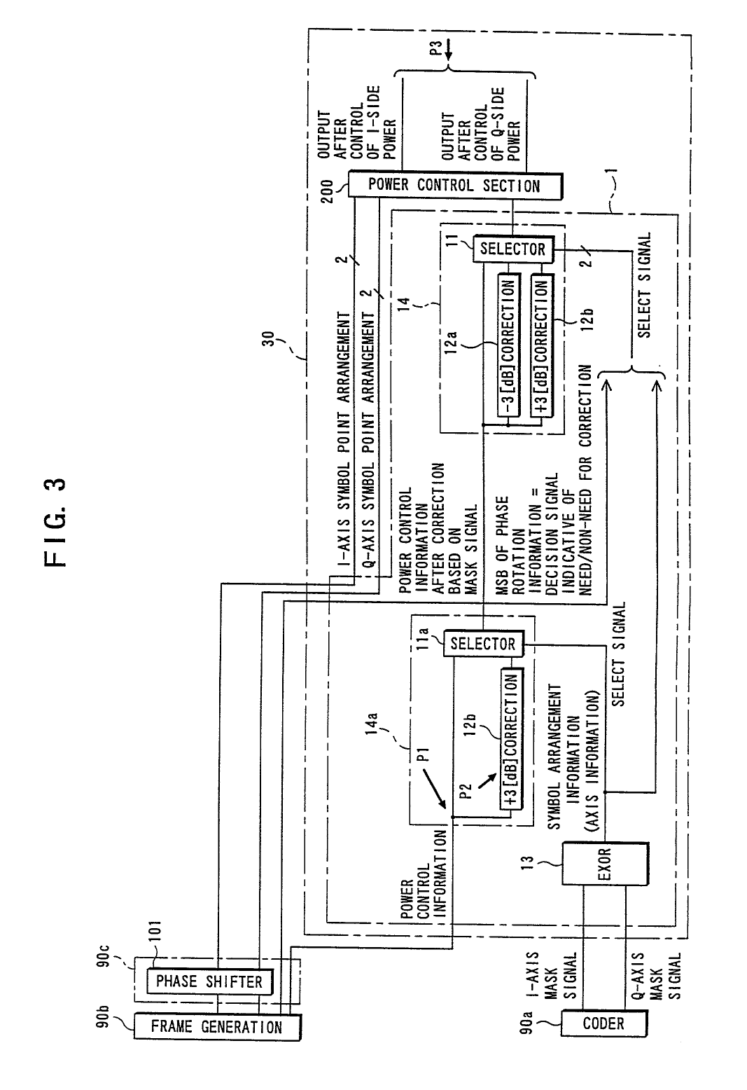

FIG. 3 is a block diagram showing the power control apparatus 30 according to the first embodiment of the present invention. As FIG. 3 shows, the power control apparatus 30 is made up of a power control section 200 and a power correcting section 1. Each of these power control section 200 and power correcting section 1 is made to receive data modulated through the use of a nine-point constellation forming a symbol point arrangement, which promotes an increase in user capacity in the case of the employment of the CDMA method.

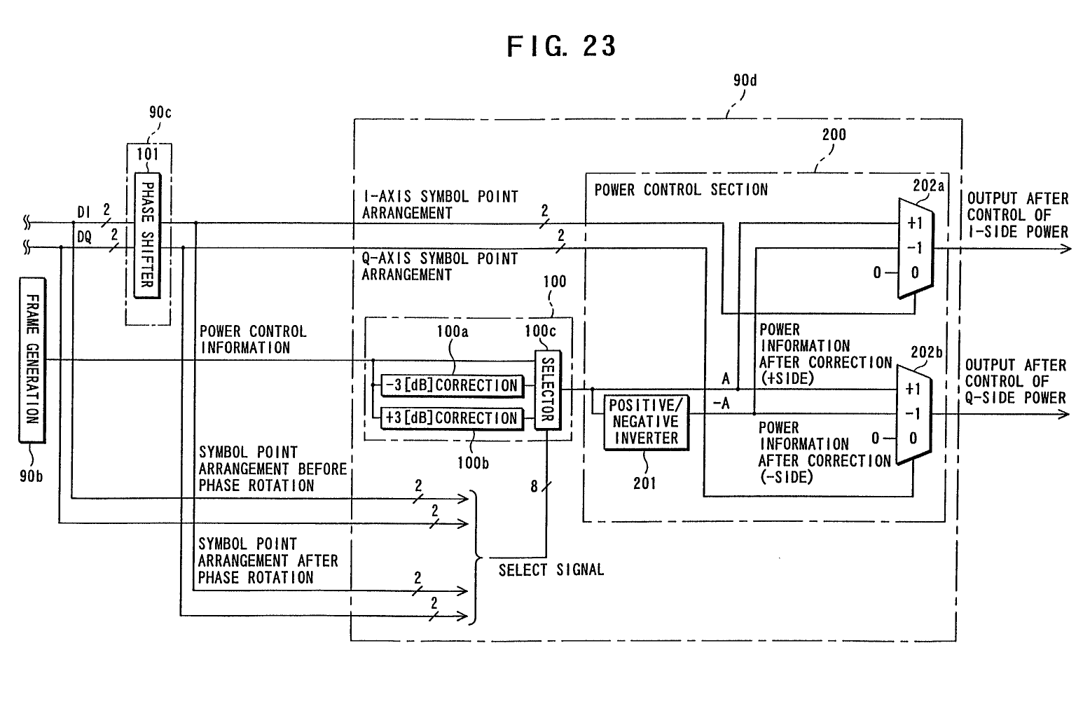

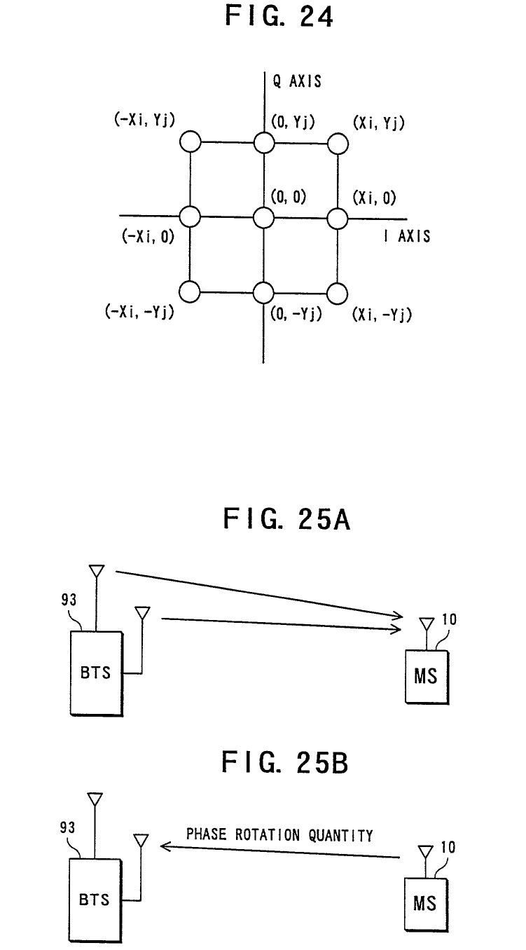

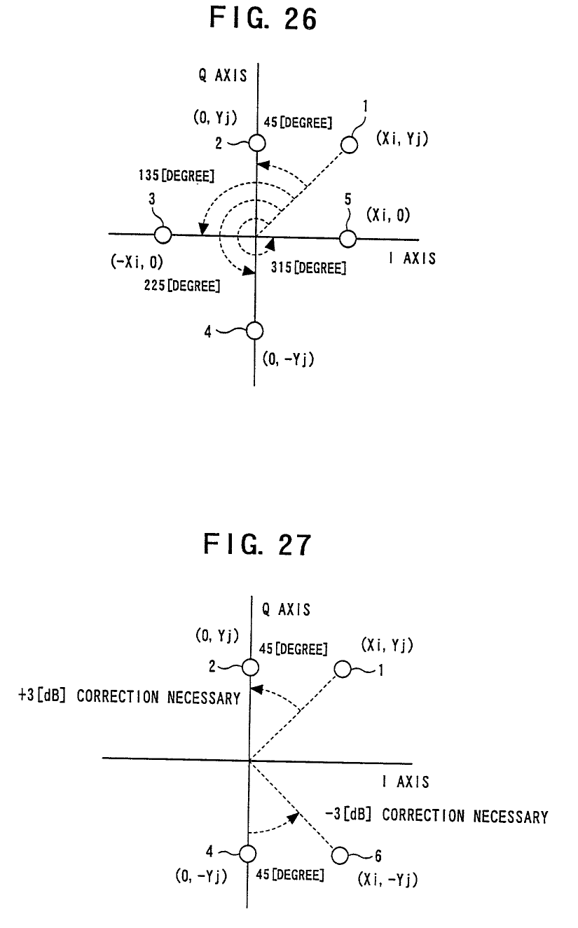

The power control section 200 is for controlling amplitude by correcting a symbol point arrangement of data on the basis of a correction amplitude value inputted from the external (a selector 11) and for outputting the amplitude-controlled data to be transmitted. This power control section 200 is the same as that shown in FIG. 23, and the description thereof will be omitted for simplicity.

The power correcting section 1 is for correcting an amplitude value of a symbol before phase rotation on the basis of a decision signal representative of need/non-need for correction of the symbol amplitude value before the phase rotation and a mask signal indicative of at least one of symbol point components being masked, and for putting the corrected amplitude value in the power control section 200. The power correcting section 1 is composed of a mask signal correcting section 14a, a phase rotation correcting section 14 and an EXOR section (symbol arrangement information arithmetic section) 13.

The mask signal correcting section 14a corrects power control information about transmission on the basis of the mask signal and outputs corrected power control information, and includes a positive correction circuit (arithmetic section) 12b and a selector (selecting section) 11a.

The positive correction circuit 12b is designed to make arithmetic processing of adding 3 [dB] to the power control information for outputting the arithmetically processed power control information. This arithmetically processed power control information is obtained by correcting the original power control information by, for example, 3 [dB] or −3 [dB], and corresponds to a symbol power value after correction. In other words, the positive correction circuit 12b is designed to make correction of 3 [dB] on the power control information. In addition, a function of the positive correction circuit 12b is realized with, for example, a logic circuit. Thus, correction is made on the value of the power control information outputted from the spread processing/phase rotating unit 90c.

In this case, the 3 [dB] correction and the −3 [dB] correction signify doubling the symbol power and halving the symbol power, respectively. This arithmetically processed power control information sometimes will be referred to hereinafter as “corrected power control information”.

Furthermore, the power control information outputted from the spread processing/phase rotating unit 90c is branched into two parts when inputted in the mask signal correcting section 14a, with one being directly inputted to the selector 11a while the other being inputted to the positive correction circuit 12b so that the corrected power control information addition-processed therein being inputted to the selector 11a. Accordingly, the addition-processed power control information obtained by adding 3 [dB] to the power control information in the arithmetic section (positive correction circuit 12b) is outputted as the corrected power control information. This enables a design with a simple logic circuit.

The selector 11a is for outputting desired one of the power control information and the corrected power control information outputted from the positive correction circuit 12b (arithmetic section) as a corrected amplitude value on the basis of a mask signal. The function of this selector 11a is realizable with, for example, a logic circuit (hardware).

In more detail, in connection with the original power control information P, the selector 11a is made to receive the corrected power control information P+3 corrected by +3 [dB] in the positive correction circuit 12b and the power control information P undergoing no correction. In addition, any one of these P and P+3 is inputted to the phase rotation correcting section 14 in accordance with a selection signal (which sometimes will be referred to hereinafter as a “select signal”).

In this way, the necessary amplitude value is attainable with a simple selection circuit, thus promoting the reduction of the circuit scale.

The EXOR section 13 shown in FIG. 3 is for outputting symbol arrangement information based upon the logic of mask signals to the selectors 11a and 11 (existing in the mask signal correcting section 14a and the phase rotation correcting section 14, respectively). Concretely, the EXOR section 13 calculates the exclusive OR of I-axis mask signal and Q-axis mask signal both of which are outputted from the coder 90a, with this function being realizable with a logic circuit. In this case, the symbol arrangement information is information representative of ì1î in the case of masking and ì1î for no masking. Incidentally, the reverse to this logic is also acceptable.

That is, in the case of masking with respect to either I axis or Q axis, “1” is inputted as the symbol arrangement information to the selector 11a. Moreover, in the case of masking or no masking with respect to both the I axis and Q axis, “0” is inputted as the symbol arrangement information to the selector 11a.

The use of this EXOR section 13 results in the logic on the I axis or Q axis agreeing with the logic on elements, thus cutting down the circuit scale.

Furthermore, the phase rotation correcting section 14 is for correcting corrected power control information outputted from the mask signal correcting section 14a on the basis of a decision signal to output a corrected amplitude value to the power control section 200. This phase rotation correcting section 14 is composed of a negative correction circuit (arithmetic section) 12a, a positive correction circuit (arithmetic section) 12b and a selector (selecting section) 11.

The negative correction circuit 12a is capable of conducting arithmetic processing of subtracting 3 [dB] from the corrected power control information for outputting the arithmetically processed corrected power control information, that is, for correcting the power control information by 3 [dB]. This function is also realizable with a logic circuit. Accordingly, the value of the power control information outputted from the spread processing/phase rotating unit 90c undergoes phase correction. In consequence, the subtracted power control information obtained by subtracting 3 [dB] from the power control information in the arithmetic section (negative correction circuit 12a) is outputted as corrected power control information. The positive correction circuit 12b is the same as that described above, and the description thereof will be omitted for brevity.

In addition, a correction amplitude value signal from the mask signal correcting section 14a is outputted as corrected power control information obtained by the correction based on a mask signal. This corrected power control information is branched into three, and one of these is directly inputted to the selector 11. One of the remaining two is inputted to the negative correction circuit 12a so that the corrected power control information undergoing the subtraction processing is outputted to the selector 11, while the other is inputted to the positive correction circuit 12b so that the corrected power control information undergoing the addition is outputted to the selector 11.

The selector 11 is made to output desired one of the corrected power control information and the arithmetically processed corrected power control information outputted from the negative correction circuit 12a and the positive correction circuit 12b (arithmetic section) as a corrected amplitude value on the basis of a decision signal and a mask signal. Likewise, the function of the selector 11 is realizable with, for example, a logic circuit.

In other words, in connection with the original power control information P, the corrected power control information P-3 undergoing −3 [dB] correction in the negative correction circuit 12a, the corrected power control information P+3 undergoing +3 [dB] correction in the positive correction circuit 12b and the power control information P undergoing no correction are inputted to the selector 11. As a result, one of P, P−3 and P+3 is inputted to the power control section 200 in accordance with a select signal.

Thus, the mask signals with respect to the I axis and Q axis, outputted from the coder 90a, are EXOR-processed in the EXOR section 13, and the EXOR-processed symbol arrangement information (axis information) is inputted to the selectors 11a and 11. In addition, in FIG. 3, the control of each unit is executed by a control section (not shown).

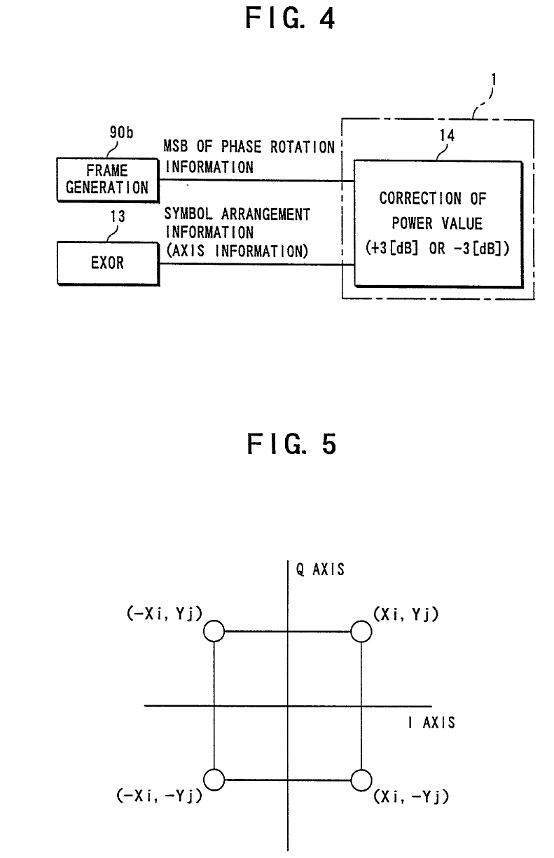

FIG. 4 is a schematic illustration of a configuration for power correction at phase rotation according to the first embodiment of the present invention. In FIG. 4, to the power correcting section 1, there are inputted an MSB (Most Significant Bit: decision signal, which will be described later) forming 1-bit phase rotation information and 1-bit symbol arrangement information (axis information). In the power correcting section 1, the phase rotation correcting section 14 is made to make ±3 [dB] correction on a power value. In addition, in FIG. 4, together with the MSB of the phase rotation information from the power control/phase correction signal outputting unit 90b, the symbol arrangement information (axis information) is power-corrected with a decision signal representative of whether a symbol before rotation is on an axis or out of an axis being generated on the basis of the before-rotation symbol point arrangement information (information from the EXOR section 13 block).

Thus, in a power control method according to the present invention, first, the mask signal correcting section 14a corrects data, placed at a symbol point (each of symbol points) through the use of the nine-point constellation, on the basis of a mask signal representative of at least one of symbol point components being masked and outputs the corrected data (constellation correcting step).

Subsequently, the phase rotation correcting section 14 corrects the corrected data in the constellation correcting step on the basis of a decision signal indicative of need/non-need for correction of an amplitude value of a symbol before phase rotation and outputs total corrected data (phase rotation correcting step).

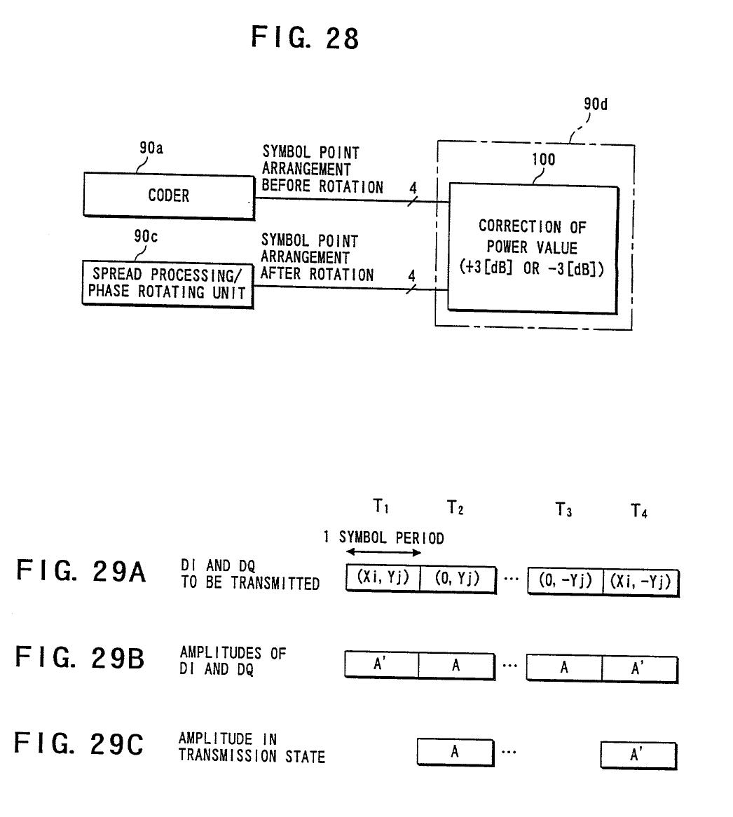

Owing to this method, the power correcting section 1 shown in FIG. 4 can decrease the number of bits to be inputted, as compared with the power correcting section 100 shown in FIG. 28, and can considerably reduce the circuit scale in view of a plurality of users.

Furthermore, a description will be given hereinbelow of a decision signal. This decision signal is representative of need/non-need for correction of an amplitude value of a symbol before phase rotation, and is expressed by MSB of the phase rotation information.

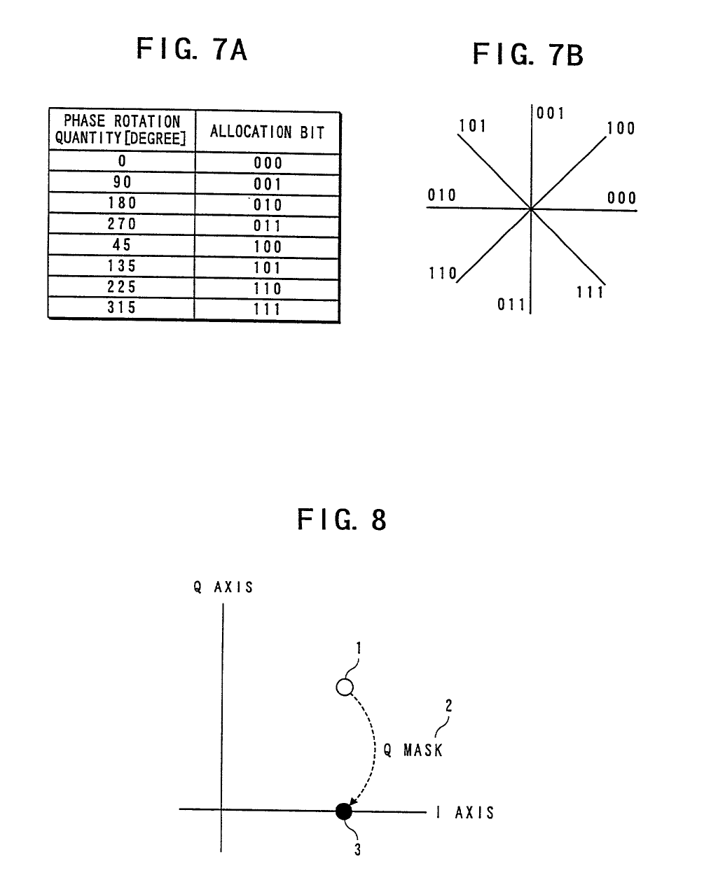

FIGS. 7A and 7B are illustrations of one example of phase rotation information according to the first embodiment of the present invention. In FIG. 7A, “rotation quantity (phase rotation quantity)” represents control information (phase rotation control information) on phase rotation, and specific three bits are allocated to that rotation quantity. Concretely, the rotation quantity (degree) selectively takes integer times of 45 [degree] in a range between 0 and +360 [degree]. In this case, since the unit circle is divided into eight in increments of 45 [degree], three bits are allocated thereto.

If the same is expressed with a symbol space, it is as shown in FIG. 7B. That is, “000”, “100”, “001”, “101”, “010”, “110”, “011” and “111” are allocated to 0, 45, 90, 135, 180, 225, 270 and 315 [degree], respectively.

In addition, determination is made previously such that the power correction is required when the MSB is “1” while being not required when the MSB is “0”. That is, the power correcting section 1 is made to output a corrected amplitude value in units of 45 degrees on a per-symbol basis. Accordingly, the base station 20 can transmit and receive a symbol point arrangement with only 2-bit information.

In other words, in the case of rotation in increments of 45 (0, 45, 90, 135, 180, 225, 270, 315) [degree], for example, the phase rotation control information indicative of that “001” corresponds to 90 [degree] is given in advance for the case requiring correction and for the case requiring no correction.

Accordingly, a decision signal is inputted from the power control/phase correction signal outputting unit 90b through the spread processing/phase rotating unit 90c to the power control section 1, and the MSB (“0” or “1”) of the phase rotation control information is inputted to the phase rotation correcting section 14 on a per-symbol basis. In addition, 1-bit symbol arrangement information based on a mask signal is inputted to the selector 11 of the phase rotation correcting section 14. Therefore, the selector 11 receives only 2-bit information.

In this way, the power correcting section 1 can seize the rotation quantity by seeing only one bit of the MSB; whereupon, control is feasible with information of two bits in total, which contributes to the reduction of the circuit scale.

FIG. 8 is an illustration useful for explaining power correction in the power correcting section 1 according to the first embodiment of the present invention, where a white circle mark represents a symbol in QPSK and a black circle mark designates a symbol in a nine-point constellation. The power control information indicated at P1 in FIG. 3 is transmission symbol power control information (a symbol power value to be actually transmitted) set with respect to the symbol indicated at the white circle mark in FIG. 6. Therefore, when modulation is made from the symbol indicated at the white circle mark to the symbol indicated at the black circle mark on the basis of a mask signal as shown in FIG. 8, the +3 [dB] correction becomes necessary.

This is because, since a symbol with intended power of 2·(A×A) is transmitted as another symbol with power of (A×A) so that the power reduces to half (an error of −3 [dB] occurs), the correction becomes necessary for compensating for this loss. In this case, A represents an amplitude. That is, at 1 in FIG. 8, for example, power of A×A is set with respect to the symbol indicated by the white circle mark. At this time, a value (see P3 in FIG. 3) of data to be transmitted, power-controlled, is (A, A).

Furthermore, when a Q-axis side symbol undergoes masking processing as indicated by 2 in FIG. 8 and is masked at 3 in the illustration, the +3 [dB] correction becomes necessary. The reason is that, since a symbol with intended power of only (A×A) is transmitted as another symbol with power of 2·(A×A) so that an error of +3 [dB] occurs, it is required to remove the excess. That is, if no correction is made, the data value becomes (A, 0) at P3 in FIG. 3.

A detailed description of a power control method employing this arrangement according to the present invention will be given hereinbelow in the case of, as one example, a transmitter involving the constellation shown in FIG. 6.

First, the spread processing/phase rotating unit 90c rotates the phase of data placed at a symbol point in a nine-point constellation for outputting data to be transmitted (phase rotating step). This phase rotating step employs the nine-point constellation as a symbol point arrangement.

The coder 90a outputs a mask signal representative of masking of at least one of symbol point components (mask signal outputting step).

The power correcting section 1 produces corrected power control information by the +3 [dB] addition and −3 [dB] subtraction to and from power control information about transmission and generating arithmetically processed power control information (corrected power control information generating step).

In addition, the power correcting section 1 selectively outputs desired one of the power control information and the corrected power control information generated in the corrected power control information generating step on the basis of a mask signal outputted in the mask signal outputting step and a decision signal representative of need/non-need for correction of an amplitude value of a symbol before phase rotation (selecting/outputting step).

Following this, the power control section 200 controls an amplitude of data to be transmitted, outputted in the phase rotating step, on the basis of the power control information or corrected power control information selectively outputted in the selecting/outputting step (amplitude controlling step). Incidentally, when the symbol before rotation resides at the origin (0, 0), it still stays at the same origin irrespective of the phase rotation, so the transmission symbol power is set at zero in the power control section 200.

Thus, in a modulating method for realizing a nine-point constellation based on mask signals, the transmission symbol power (amplitude value) is adjusted after the symbol phase rotation, which contributes to the reduction of the circuit scale.

In addition, a decision on need/non-need for power correction can be made on a per-symbol basis in this way, and the information thereon is obtainable with a 1-bit decision signal. Still additionally, a decrease in number of control bits needed for the power correction in the power correcting section 1 is achievable, so the circuit scale is reducible.

Moreover, the power correcting section 1 can seize the arrangement of symbols before rotation from the 1-bit information based on the exclusive OR of the I-axis and Q-axis mask signals.

Since a signal which becomes effective only when only the one components of the I-axis and Q-axis mask signals are effective is generated utilizing the fact that a symbol before rotation exists on an axis, the reduction of the circuit scale is feasible. When the need for power correction exists, 2-bit processing becomes possible with the effective signals of the mask signals.

(A1) Description of First Modification of First Embodiment

In the above-described first embodiment, for example, the power control apparatus 30 shown in FIG. 3 is made to make separately the correction based on the nine-point constellation (correction depending on mask) and the correction based on the phase rotation. That is, the power is corrected at two stages and two types of selectors 11 and 11a are necessary. On the other hand, in the first modification, these two types of selectors 11 and 11a are integrated functionally into a single unit.

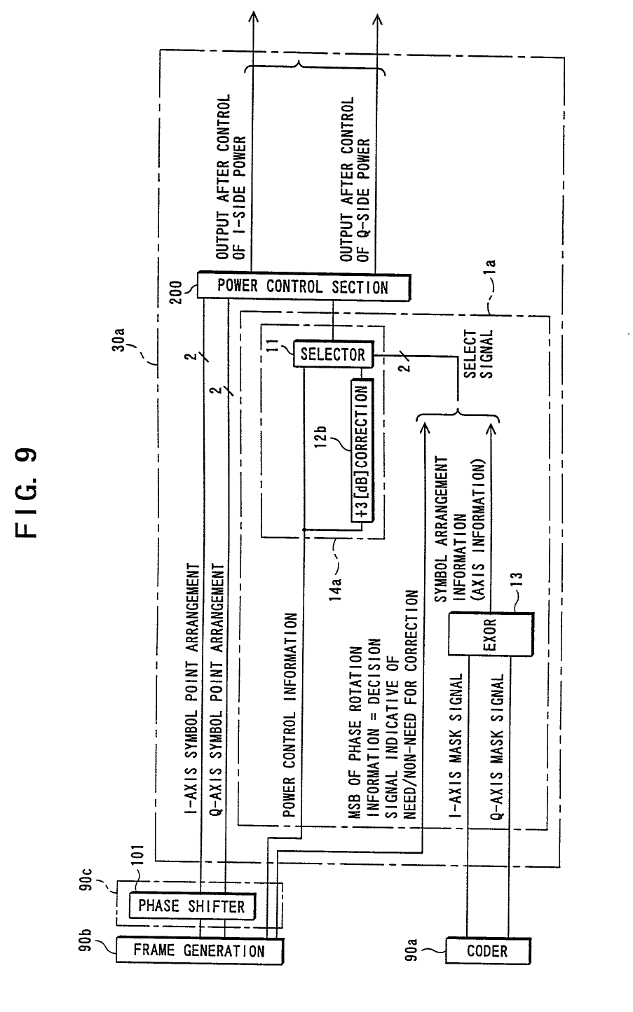

FIG. 9 is a block diagram showing a power control apparatus according to a first modification of the first embodiment of the present invention. In FIG. 9, a power control apparatus 30a is made to accomplish power control or power correction of spread data for each user, outputted from the spread processing/phase rotating unit 90c (see FIG. 2). In FIG. 9, parts marked with the same reference numerals as those used above are made to provide the same or corresponding functions, and the description thereof will be omitted for brevity.

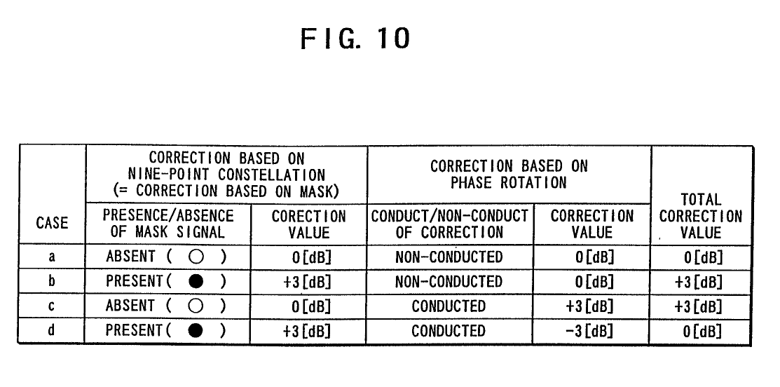

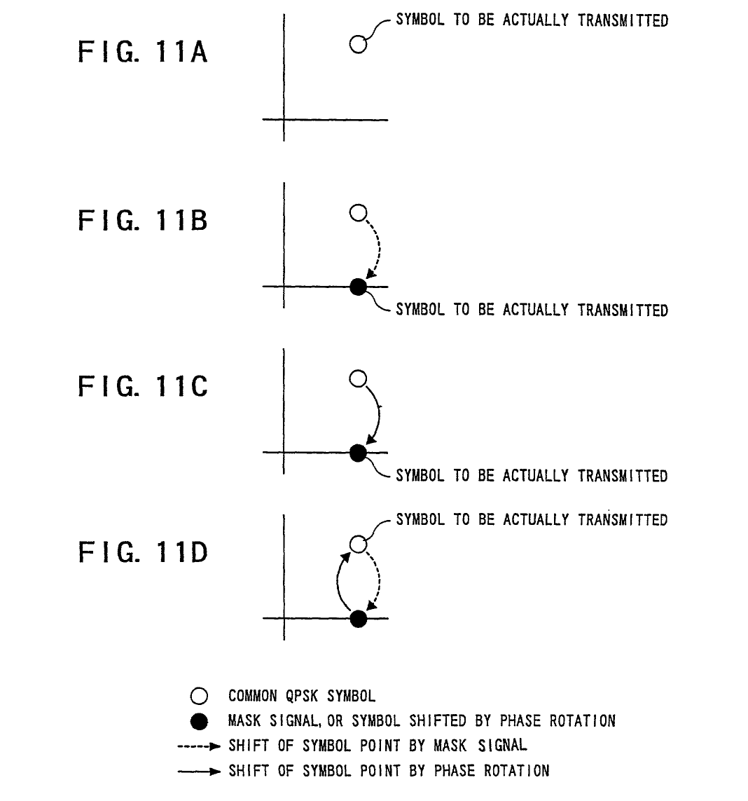

This power control apparatus 30a is designed to perform correction (which sometimes will be referred to as hereinafter as “total correction”) combining the correction based on the nine-point constellation and the correction based on the phase rotation. This will be described hereinbelow with reference to FIGS. 10 and 11A to 11d.

FIG. 10 is an illustration useful for explaining a total correction value in the power control apparatus 30a according to the first modification of the first embodiment of the present invention. In the right and left columns of the table of FIG. 10, there are shown four types of patterns (case; a to d) for correction values in the case of correction based on the nine-point constellation and for correction values in the case of correction based on the phase rotation. In this illustration, white circle marks and black circle marks signify symbols indicated by white circle marks and symbols indicated by black circle marks in the nine-point constellation shown in FIG. 6, respectively.

FIGS. 11A to 11D are illustrations useful for explaining symbol states according to the first modification of the first embodiment of the present invention, where the horizontal axes represent the I axes and the vertical axes denote the Q axes.

In FIG. 10, the case a corresponds to the symbol state shown in FIG. 11A, and the white circle mark in FIG. 11A represents a symbol to be actually transmitted. Accordingly, the symbol in the case a in FIG. 10 is not masked, so the mask signal is “absent” and the correction value assumes 0 [dB]. In addition, because the correction is not made by phase rotation, the correction is “non-conducted” and the correction value becomes 0 [dB].

In FIG. 10, the case b corresponds to the symbol state shown in FIG. 11B, and the symbol to be actually transmitted is on the I axis as indicated by the black circle mark. The shift of the symbol point from the white circle mark to the black circle mark depends on a mask signal. Thus, since the symbol in the case b is masked, when the case b in FIG. 10 is referred to, the mask signal is “present” and the correction value becomes +3 [dB]. In addition, because the correction is not made by phase rotation, the correction is shown as “non-conducted” and the correction value becomes 0 [dB]. As a result, the total correction value adds up to +3 [dB]. In FIG. 11B, an arrow written by a dotted line signifies the shift due to the mask signal.

Furthermore, the case c in FIG. 10 corresponds to the symbol state shown in FIG. 11C, and the symbol to be actually transmitted is on the I axis as indicated by the black circle mark. The shift of the symbol point from the white circle mark to the black circle mark depends upon phase rotation. Thus, since the symbol is rotated in phase, when the case c in FIG. 10 is referred to, the mask signal is “absent” and the correction value is 0 [dB]. On the other hand, the correction based on the phase rotation is “conducted” and the correction value becomes +3 [dB]. In consequence, the total correction value adds up to +3 [dB]. In FIG. 11C, an arrow written by a solid line represents the shift based on the phase rotation. In the following description, dotted lines or solid lines will be used in the same sense.

Still furthermore, the case d in FIG. 10 corresponds to the symbol state shown in FIG. 11D, and the symbol to be actually transmitted is in the out-of-axis condition as indicated by the white circle mark. In this case, the symbol indicated by the white circle mark is once shifted to the on-I-axis condition by a mask signal, but is again returned to the out-of-axis condition by the phase rotation to be transmitted as a symbol at the original position. When the case d in FIG. 10 is referred to, the mask signal is “present” and the correction value is +3 [dB]. Moreover, the correction based on the phase rotation is “conducted” and the correction value becomes −3 [dB]; therefore, the total correction value amounts to 0 [dB].

As described above, since the correction based on the nine-point constellation and the correction based on the phase rotation are handled as the total correction, an efficient design is possible on the circuit, thereby reducing the circuit scale significantly.

With the above-described arrangement, the spread processing/phase rotating unit 90c phase-rotates data placed at a symbol point through the use of the nine-point constellation to output data to be transmitted (phase rotating step), and the coder 90a outputs a mask signal representative of masking at least one of symbol point components (mask signal outputting step).

In addition, a power correcting section la performs the +3 [dB] addition and 3 [dB] subtraction to and from power control information about transmission to generate corrected power control information (corrected power control information generating step), and selectively outputs desired one of the power control information and the corrected power control information generated, on the basis of a mask signal outputted in the mask signal outputting step and a decision signal representative of need/non-need for correction of an amplitude value of a symbol before phase rotating (selecting/outputting step).

Still additionally, the power control section 200 controls an amplitude of data to be transmitted in the phase rotation step, outputted, on the basis of the power control information or the corrected power control information selectively outputted in the selecting/outputting step (amplitude controlling step).

In this way, in the nine-point constellation the transmission symbol power is adjusted after the symbol phase rotation.

Moreover, in addition to the advantages of the first embodiment, the correction based on the nine-point constellation and the correction based on the phase rotation are achievable in batches in the power control apparatus 30a.

Accordingly, the number of control bits needed for the power correction in the power correcting section 1a decreases, which cuts down the circuit scale.

(A2) Description of Second Modification of First Embodiment

Although the modulation method in the above-described first embodiment and first modification thereof is based upon the common QPSK, the modulation method in this second modification employs 45-degree shift QPSK. This 45-degree shift QPSK is for use in a system using W-CDMA (Wide Band-CDMA). That is, in the case of the 45-degree shift QPSK, the phase is shifted by 45 [degree] in advance, and a symbol before phase rotation is positioned on the I axis or Q axis when no mask signal exists while being placed at an out-of-axis position when a mask signal occurs.

Incidentally, also in the second modification, the system 100 and the transmitter of the base station 20 are similar in configuration to those shown in FIGS. 1 and 2.

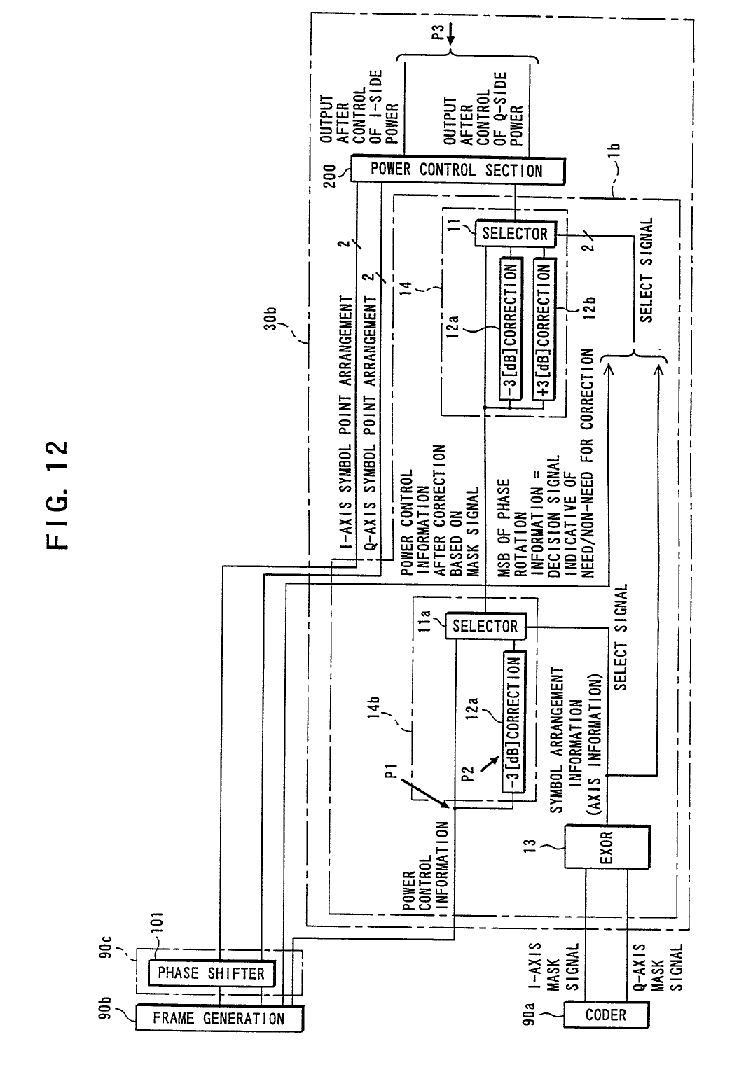

FIG. 12 is a block diagram showing a power control apparatus according to the second modification of the first embodiment of the present invention. As FIG. 12 shows, a difference of a power control apparatus 30b according to the second modification from the power control apparatus 30 (see FIG. 3) is that a phase rotation correcting section 14b is designed to make −3 [dB] correction.

This phase rotation correcting section 14b is for correcting the value of power control information outputted from the spread processing/phase rotating unit 90c, and is made up of a negative correction circuit (arithmetic section) 12a and a selector (selecting section) 11a.

Incidentally, parts marked with the same reference numerals as those used above provide the same or corresponding functions, and the description thereof will be omitted for simplicity.

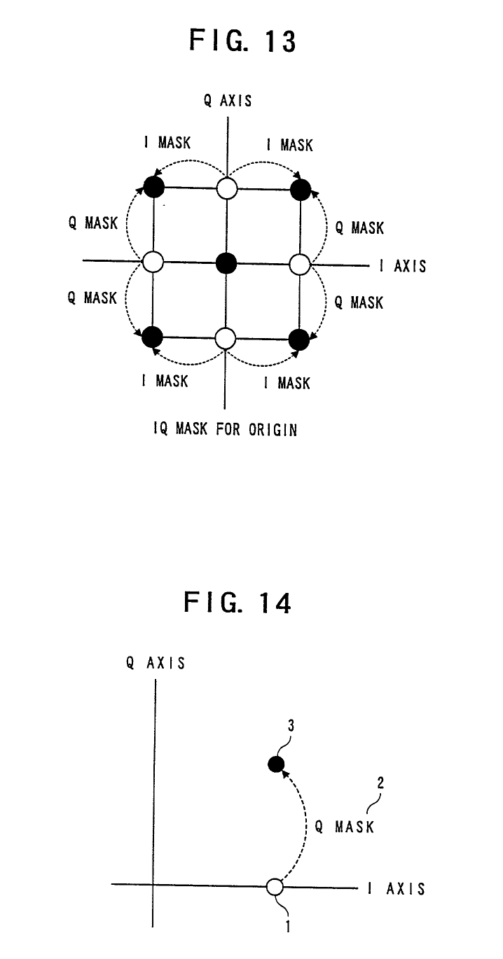

In this arrangement, because of the employment of the 45-degree shift QPSK, for example, a nine-point constellation shown in FIG. 13 is realizable by masking one of the I-axis and Q-axis symbols at the QPSK modulation which makes a 45-degree phase shift with respect to the common QPSK.

FIG. 13 is an illustration of a symbol point arrangement in a nine constellation according to the 45-degree shift QPSK. As FIG. 13 shows, the symbol points indicated by white circle marks and the symbol points indicated by black circle marks are in contrast with those of the nine-point constellation shown in FIG. 6. That is, due to the masking, the symbols indicated by the white circle marks, which are on the I axis and Q axis, correspond to the symbols indicated by the black circle marks in FIG. 6. In this case, the origin is selected by making both the I axis and Q axis.

In this connection, in the nine-point constellation (see FIG. 6), when no mask signal exists, a symbol before rotation is placed at an out-of-axis position.

FIG. 14 is an illustration useful for explaining power correction in the power correcting section 1b according to the second modification of the first embodiment of the present invention, where a white circle mark represents a symbol in the case of the common QPSK and a black circle mark depicts a symbol in the nine-point constellation. The power control information indicated at P1 in FIG. 12 is transmission symbol power control information (=a symbol power value to be actually transmitted) set with respect to the common QPSK symbol indicated by the black circle mark in FIG. 13. Accordingly, when the modulation is made from the white circle mark to the black circle mark through the use of a mask signal, the symbols become as shown in FIG. 13; therefore, a need for the −3 [dB] correction exists in this case.

That is, at 1 in FIG. 14, for example, power A is set for a symbol indicated by the while circle mark. At this time, the data (see P3 in FIG. 12) power-controlled is (A, 0) and the transmission power is (A, A), where A represents an amplitude. Subsequently, the Q-axis side symbol is masking-processed as indicated by 2 to be masked at 3. Accordingly, a need for the −3 [dB] correction exists and, therefore, the negative correction circuit 12a is provided as shown in FIG. 12. This is because, if the correction is not made, (A, A) appears at P3 in FIG. 12.

With this arrangement, the symbol power in the second modification is corrected in a manner almost similar to that in the first embodiment. In addition, by the reversal of the mask signal logic shown in FIG. 3, power control employing another nine-point constellation becomes feasible.

In this way, in the nine-point constellation, the transmission symbol power is adjusted after the symbol phase rotation to decrease the number of control bits needed for the power correction in the power correcting section 1b, which results in cutting down the circuit scale.

(A3) Description of Third Modification of First Embodiment

Even in the case of the use of the 45-degree shift QPSK in the W-CDMA method, two-step power correction can be integrated into one-step correction to reduce the circuit scale.

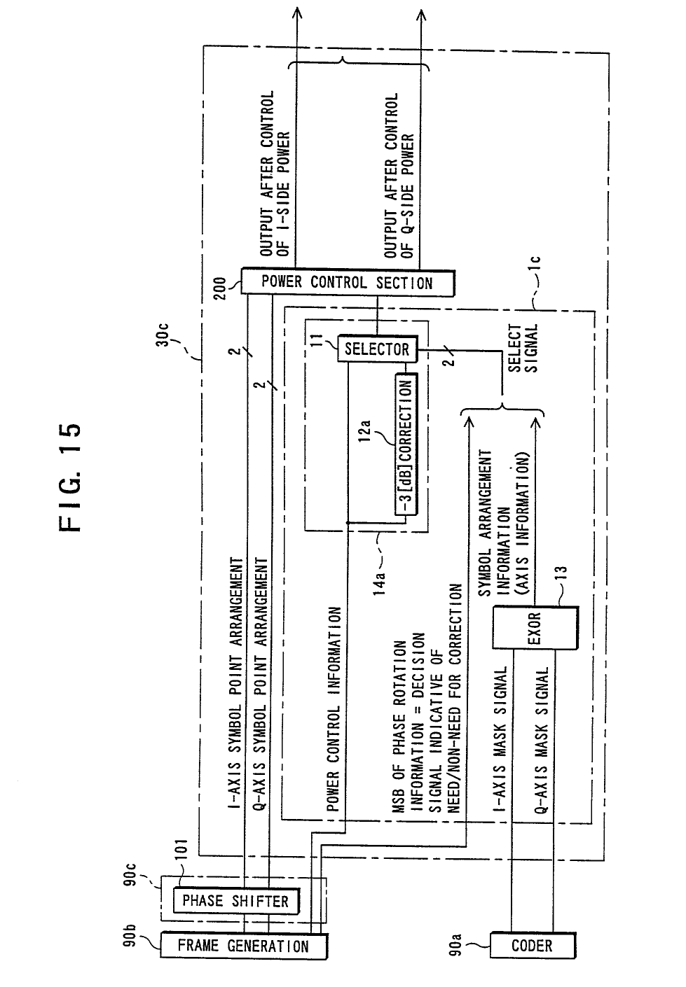

FIG. 15 is a block diagram showing a power control apparatus according to a third modification of the first embodiment of the present invention. A power control apparatus 30c shown in FIG. 15 is for performing power control or power correction of spread data for each user, outputted from the spread processing/phase rotating unit 90c (see FIG. 2). In other words, the power control apparatus 30c is designed to make the correction based on the nine-point constellation and the correction based on the phase rotation at a stretch.

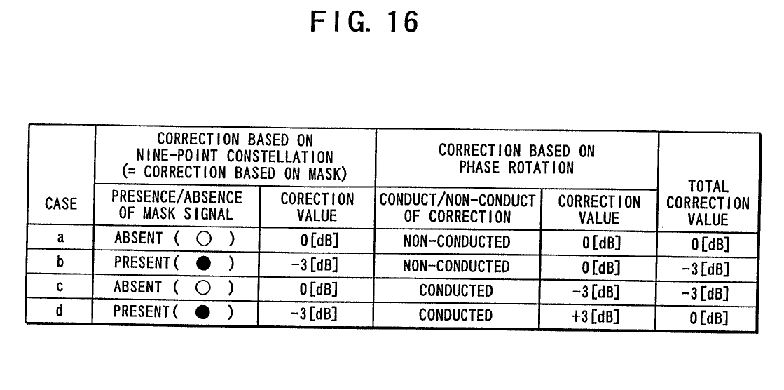

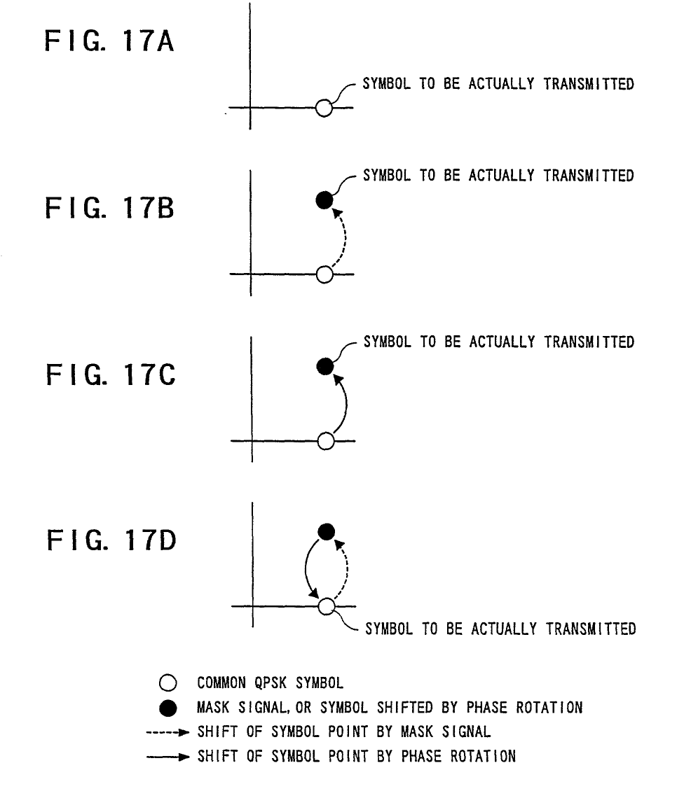

In FIG. 15, parts marked with the same reference numerals as those used above have the same or corresponding functions, and the description thereof will be omitted for brevity. A total correction value will be described hereinbelow with reference to FIGS. 16 and 17A to 17D.

FIG. 16 is an illustration useful for explaining a total correction value in the power control apparatus 30c according to the third modification of the first embodiment of the present invention. In the right and left columns of the table of FIG. 16, there are shown four types of patterns for correction values in the case of correction (correction by masking) based on the nine-point constellation and for correction values in the case of correction based on the phase rotation. In this illustration, white circle marks and black circle marks signify symbols indicated by white circle marks and symbols indicated by black circle marks in the nine-point constellation shown in FIG. 13, respectively.

FIGS. 17A to 17D are illustrations useful for explaining symbol states according to the third modification of the first embodiment of the present invention, where the horizontal axes represent the I axes and the vertical axes denote the Q axes.

In FIG. 16, the case a corresponds to the symbol state shown in FIG. 17A, and the white circle mark in FIG. 17A represents a symbol to be actually transmitted. In the case a in FIG. 16, the mask signal is “absent” and the correction based on phase rotation is “non-conducted”; therefore, the total correction value becomes 0 [dB].

In FIG. 16, the case b corresponds to the symbol state shown in FIG. 17B, and the symbol to be actually transmitted is in an out-of-axis condition as indicated by the black circle mark. In this case, the shift of the symbol point from the white circle mark to the black circle mark depends on a mask signal. Thus, seeing the case b in FIG. 16, the mask signal is “present” and the correction value becomes −3 [dB]. In addition, the correction based on the phase rotation is “non-conducted” and the total correction value becomes −3 [dB].

Furthermore, the case c in FIG. 16 corresponds to the symbol state shown in FIG. 17C, and the symbol to be actually transmitted is in the out-of-axis condition as indicated by the black circle mark. The shift of the symbol point from the white circle mark to the black circle mark depends upon phase rotation. Thus, seeing the case c in FIG. 16, the mask signal is “absent”. On the other hand, the correction based on the phase rotation is “conducted” and the correction value becomes −3 [dB]. In consequence, the total correction value adds up to −3 [dB].

Still furthermore, the case d in FIG. 16 corresponds to the symbol state shown in FIG. 17D, and the symbol to be actually transmitted is on the I axis condition as indicated by the white circle mark. In this case, the symbol indicated by the white circle mark is once shifted to the out-of-axis condition by a mask signal, but is again returned to the on-I-axis condition by the phase rotation to be transmitted as a symbol at the original position. When the case d in FIG. 16 is referred to, the mask signal is “present” and the correction value is −3 [dB]. Moreover, the correction based on the phase rotation is “conducted” and the correction value becomes +3 [dB]; therefore, the total correction value amounts to 0 [dB].

As described above, since the correction based on the nine-point constellation and the correction based on the phase rotation are handled as the total correction, an efficient design is possible on the circuit, thereby reducing the circuit scale significantly.

With the above-described arrangement, the symbol power in the third modification can be corrected in an almost similar manner to the first modification of the first embodiment.

In this way, in the nine-point constellation, the transmission symbol power is adjusted after the symbol phase rotation to decrease the number of control bits needed for the power correction in the power correcting section 1c, which results in cutting down the circuit scale.

(A4) Description of Fourth Modification of First Embodiment

In each of the above-described embodiments or modifications, the I-axis and Q-axis mask signals are made with one bit in the EXOR section 13. In a fourth modification, without the use of the EXOR section 13, processing is conducted in the form of three bits. That is, in the fourth modification, a number of signal bits to be inputted to each of the selectors 11 and 11a included in the power control apparatus 30 (see FIG. 3) and the power control apparatus 30b (see FIG. 12) are set to be three, thereby eliminating the need for the EXOR section 13.

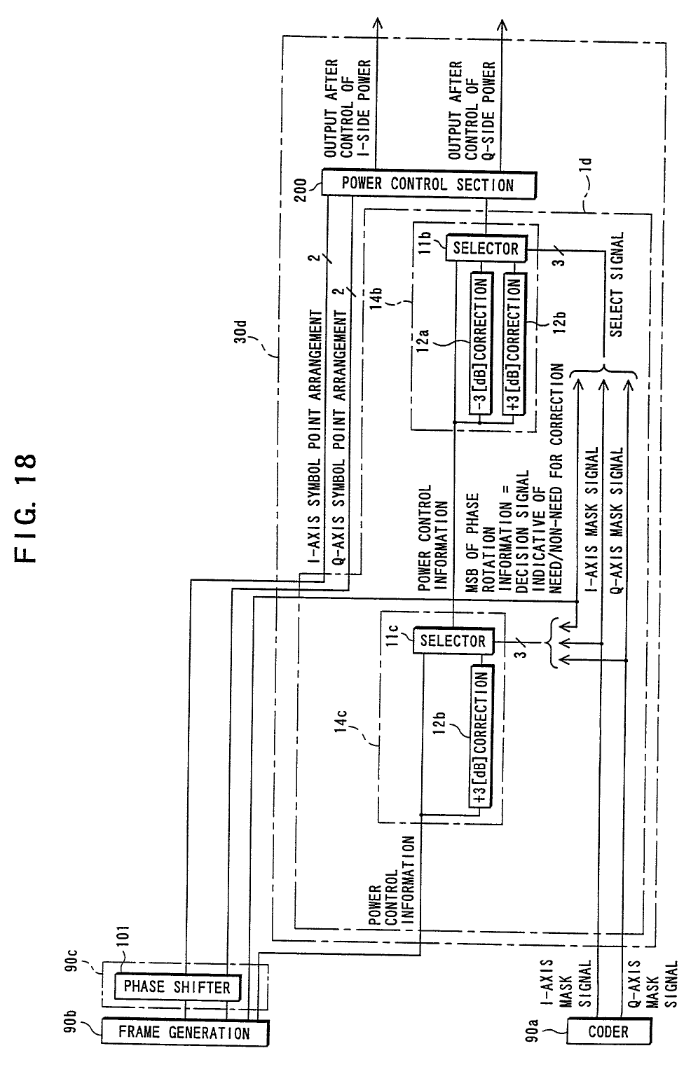

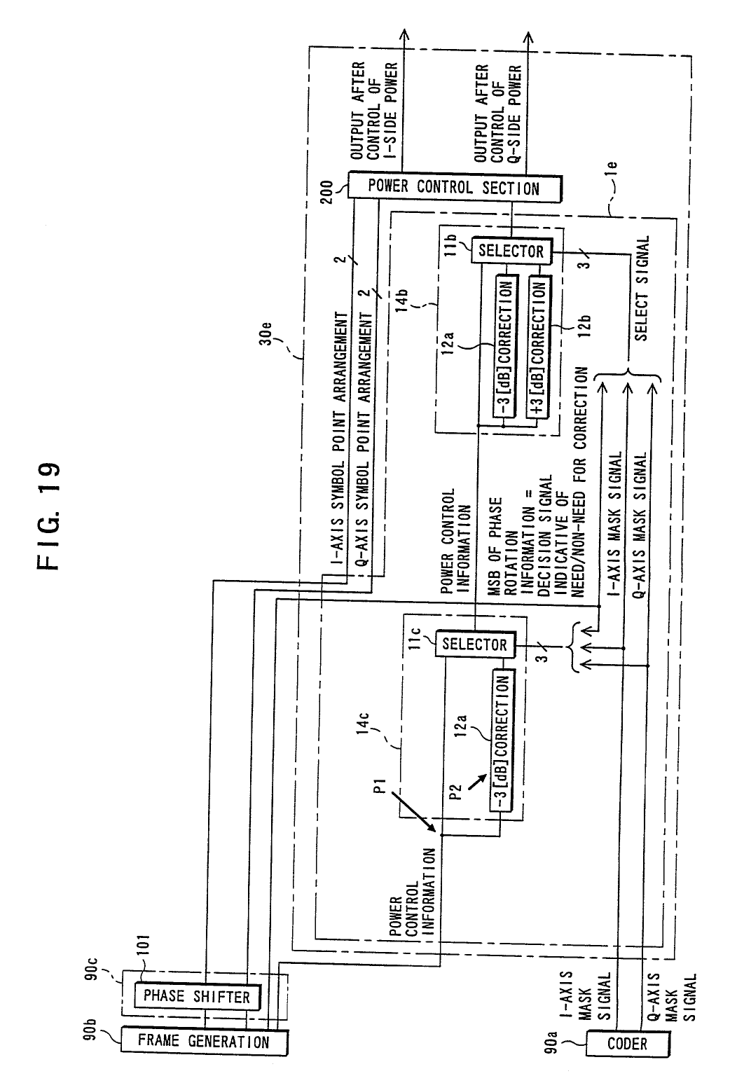

FIG. 18 is a block diagram showing a power control apparatus according to the fourth modification of the first embodiment of the present invention, and FIG. 19 is a block diagram showing another power control apparatus according to the fourth modification of the first embodiment of the present invention. In FIGS. 18 and 19, each of power control apparatuses 30d and 30e is made to perform power control or power correction of spread data for each user, outputted from the spread processing/phase rotating unit 90c.

In FIG. 18, a power correcting section 1d is for correcting an amplitude value of a symbol before phase rotation on the basis of a decision signal representative of need/non-need for correction of the symbol amplitude value before the phase rotation and a mask signal indicative of at least one of symbol point components being masked, and further for putting the corrected amplitude value in the power control section 200. The power correcting section 1d is composed of a mask signal correcting section 14c and a phase rotation correcting section 14b.

The mask signal correcting section 14c is for correcting power control information about transmission on the basis of a mask signal to output the corrected power control information, and includes a positive correction circuit 12b and a selector 11c. This selector 11c is for selectively outputting desired one of the power control information and the corrected power control information outputted from the positive correction circuit 12b as a corrected amplitude value on the basis of a decision signal and a mask signal.

In addition, in FIG. 18, the phase rotation correcting section 14b is for correcting the corrected power control information, outputted from the mask signal correcting section 14c, on the basis of a decision signal to input a corrected amplitude value to the power control section 200, and includes a negative correction circuit 12a, a positive correction circuit 12b and a selector 11b. The selector 11b is for selectively outputting desired one of the power control information and the corrected power control information outputted from the negative correction circuit 12a and the positive correction circuit 12b (arithmetic section) as a corrected amplitude value on the basis of a decision signal and a mask signal.

Each of the selectors 11b and 11c internally has an EXOR circuit (not shown) and a number of bits of a select signal is made with three bits, and this point makes a difference from the selectors 11 and 11a. The functions of the selectors 11b and 11c are realizable with, for example, a logic circuit.

In FIGS. 18 and 19, parts marked with the same reference numerals as those used above have the same or corresponding functions, and the description thereof will be omitted for simplicity.

In addition, the power control apparatus 30d is designed to conduct both the correction based on the nine-point constellation and the correction based on the phase rotation. Still additionally, the total correction value is calculated as in the cases described above with reference to FIGS. 10 and 11A to 11D, and the description thereof will be omitted for avoiding the repeated explanation.

Accordingly, in FIG. 18, the coder 90a puts I-axis and Q-axis mask signals in the power control apparatus 30d. The inputted I-axis and Q-axis mask signals and a decision signal inputted from the spread processing/phase rotating unit 90c are inputted to the mask signal correcting section 14c and further to the phase rotation correcting section 14b. Thus, the power control apparatus 30d receives a 3-bit select signal. The power control apparatus 30e shown in FIG. 19 is almost similar to the power control apparatus 30d, and is made to perform both the correction based on the nine-point constellation and the correction based on the phase rotation. Moreover, the total correction value is calculated as with the cases described above with reference to FIGS. 16 and 17A to 17D, and the description thereof will be omitted for avoiding the repeated explanation.

With the arrangement shown in FIG. 18, in the power control apparatus 30d, the symbol power is corrected in an almost similar way to the first modification of the first embodiment.

In this way, in the nine-point constellation, the transmission symbol power is corrected after the symbol phase rotation, and the number of control bits needed for the power correction in the power correcting section 1d is reducible, which contributes to the reduction of the circuit scale.

Furthermore, with the arrangement shown in FIG. 19, in the power control apparatus 30e, the power is corrected as in the case of the power control apparatus 30d and the circuit scale is considerably reducible. In this case, although the power correction requires three bits, the circuit scale is further reducible as compared with a common unit using eight bits. In this arrangement, two types of correction can be made at a stretch.

As stated above, unlike the above-described power control apparatus 30 and other units, in the case of the power control apparatuses 30d and 30e, since the EXOR section 13 is not provided on the select signal input side of the phase rotation correcting section 14b and the mask signal correcting section 14c, the circuit scale is further reducible.

(B) Description of Second Embodiment of the Invention

FIG. 20 is a block diagram showing a power control apparatus according to a second embodiment of the present invention. A power control apparatus 30f shown in FIG. 20 is for performing power control or power correction of spread data for each user, outputted from the spread processing/phase rotating unit 90c. This power control apparatus 30f differs from the power control apparatus 30 according to the first embodiment in that the phase rotation based on the nine-point constellation is not made. Also in the second embodiment, the configurations of the system 100 and the base station 20 are similar to those described as the first embodiment, and the description thereof will be omitted for brevity.

In the power control apparatus 30f, power control information outputted from the spread processing/phase rotating unit 90c is directly inputted to a phase rotation correcting section 14 without being phase-rotated in the nine-point constellation. In addition, the I-axis and Q-axis mask signals outputted from the coder 90a are inputted to a selector 11. This means that only the masking correction can achieve the 45 [degree] rotation of a symbol point.

In this connection, it is also possible that the EXOR section 13 is provided in a signal line extending from the coder 90a to the selector 11. Even in this case, the circuit scale is also reducible.

With this arrangement, the power control apparatus 30f achieves the masking correction without phase-rotating data DI and DQ before phase rotation.

Thus, only the mask signals enable the phase rotation of a symbol point to accomplish the power correction. In addition, in the nine-point constellation, the transmission symbol power is adjusted after the symbol phase rotation so that the number of control bits needed for the power correction in the power correcting section is reducible, which contributes to the reduction of the circuit scale.

(C) Description of Third Embodiment of the Invention

A description of a third embodiment will be made about a four-point constellation (see FIG. 5).

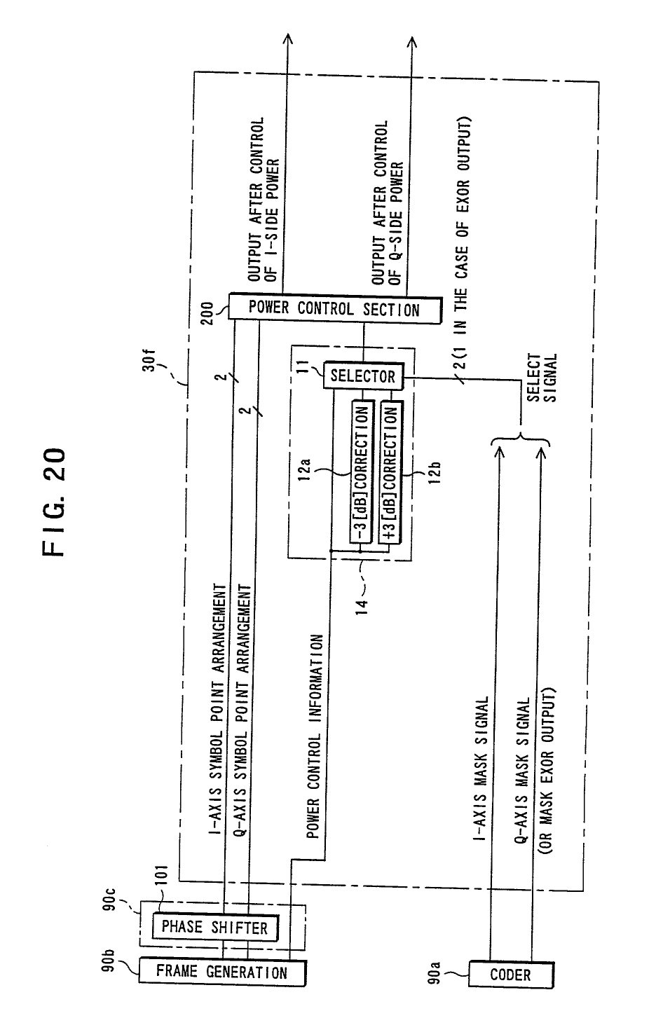

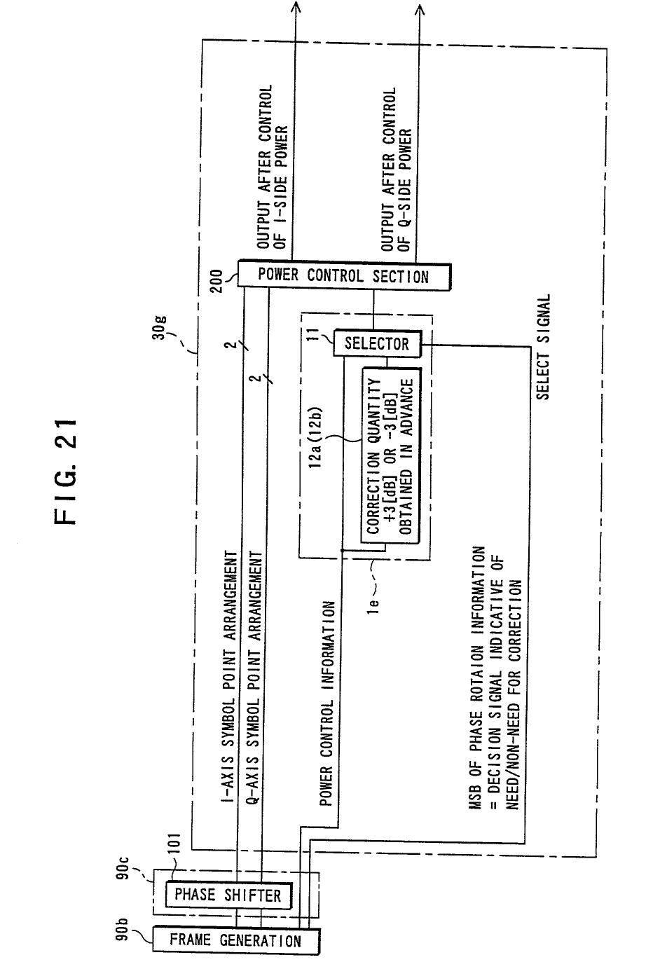

FIG. 21 is a block diagram showing a power control apparatus according to a third embodiment of the present invention. In FIG. 21, a power control apparatus 30g is designed to perform power control or power correction of spread data for each user, outputted from the spread processing/phase rotating unit 90c, and is composed of a power correcting section 1e and a power control section 200.

The power correcting section 1e is for correcting an amplitude value of a symbol before phase rotation on the basis of a decision signal representative of need/non-need for correction the symbol amplitude value before the phase rotation and a mask signal indicative of at least one of symbol point components being masked to input the corrected amplitude value to the power control section 200. This power correcting section 1e is composed of a selector 11 and a negative correction circuit 12a (or a positive correction circuit 12b).

In FIG. 21, parts marked with the same reference numerals as those used above provide the same or corresponding functions, and the description thereof will be omitted for brevity.

In the case of four-point constellation (five points if the origin is included), first, a necessary correction value (for example, +3 [dB] or −3 [dB]) is obtained through calculations or the like with respect to a constellation (signifying each of four points of QPSK) in the case of no phase rotation. Secondly, power control information and a decision signal for each symbol (for when the rotation quantity is at each of 45, 135, 215 and 315 [degree]) are inputted to the power correcting section 1e.

In a case in which this arrangement is employed, in a power control method according to the present invention, the spread processing/phase rotating unit 90c first phase-rotates data placed at a symbol point using the four-point constellation to output data to be transmitted (phase rotating step).

Next, the power correcting section 1e having a desired correction quantity for each symbol point corrects power control information on the basis of a decision signal representative of need/non-need of an amplitude value of a symbol before phase rotation to output the corrected power control information (corrected power control information outputting step).

Following this, the power control section 200 controls an amplitude of data to be transmitted, outputted in the phase rotating step, using the corrected power control information outputted in the corrected power control information outputting step.

Thus, the power correcting section 1e can seize the need/non-need for correction by a 1-bit decision signal according to symbol.

In addition, since the number of control bits decreases, the power correcting section 1e can contribute to the reduction of the circuit scale.

(D) Description of Fourth Embodiment of the Invention

In connection with the above-described symbol point arrangement, in addition to the phase rotation, the present invention is also applicable to modulation for shifting phases.

That is, a power control apparatus (not shown) according to a fourth embodiment of the present invention is made up of a power control section for performing an amplitude adjustment by adjusting a symbol point arrangement of data on the basis of an adjustment amplitude value inputted from the external and for outputting amplitude-adjusted data to be transmitted, and a power adjusting section for adjusting an amplitude value of a symbol before phase shift to input the amplitude-adjusted value to the power control section on the basis of a decision signal representative of need/non-need for adjustment of the symbol amplitude value before the phase shift and a mask signal indicative of a phase shifted position resulting from a symbol point component.

This configuration enables correction based on the nine-point constellation and phase shift corresponding to the correction based on a mask signal so that the power control is achievable.

Thus, even the phase shift, other than the phase rotation, permits the adjustment of the transmission symbol power and decreases the number of control bits needed for the power correction in the power correcting section, thus cutting down the circuit scale.

(E) Others

It should be understood that the present invention is not limited to the above-described embodiments and modifications, and that it is intended to cover all changes and modifications of the embodiments of the invention herein which do not constitute departures from the spirit and scope of the invention.

Although the above-mentioned arithmetic section (negative correction circuit 12a, positive correction circuit 12b) has been designed to make, for example, the 3 [dB] or −3 [dB] correction with respect to the original power control information, the present invention is not limited to these values. That is, it is also possible that, through a change of design, the original power control information is corrected to values other than these values.

In addition, although the phase rotation information has used three bits for 45 [degree] steps, the rotation quantity can also be subdivided more finely. In this case, four or more bits will be used therefor. Therefore, even in a case in which the system 100 employs a multi-valued PSK modulation, for example, four or more phases, it is practicable with slight alteration.

Still additionally, the allocation of this phase rotation information is also practicable within a range of −180 to +180 [degree]. For example, it is also possible that “000”, “100”, “001”, “101”, “010”, “110”, “011” and “111”are allocated to 0, 45, 90, 135, 180, −135, −90 and −45 [degree], respectively.

Moreover, the method described above as the fourth embodiment is also applicable to modulation methods such as multi-valued (for example, four or more phase) PSK or multi-valued QAM (Quadrature Amplitude Modulation). In this case, the amplitude adjustment implies, in addition to the ±3 [dB] correction amplitude, setting the amplitude at a predetermined magnitude.

Still moreover, in the above description, although the data to be inputted to the RF circuit 90f has been much like the data to be transmitted in which the amplitude value has already been corrected, it is also possible that a circuit is provided which, for example, squares the corrected amplitude value to convert it into power.

That is, according to the present invention, it is also appropriate that a power control apparatus (not shown) comprises a transmission symbol power adjusting section made to adjust the transmission symbol power on the basis of a corrected amplitude value outputted from a power correcting section.

The employment of this transmission symbol power adjusting section enables, for example, wire transmission in addition to radio transmission.

The power control apparatus 30a shown in FIG. 9, the power control apparatus 30b shown in FIG. 12, the power control apparatus 30c shown in FIG. 15 and the power control apparatus 30e shown in FIG. 19 includes the power correcting section 1a, the power correcting section 1b, the power correcting section 1c and power correcting section 1e, respectively. Each of these power correcting sections 1a, 1b, 1c and 1e is made to correct an amplitude value of a symbol before phase rotation on the basis of a decision signal indicative of need/non-need for correction the symbol amplitude value before the phase rotation and a mask signal indicative of at least one of symbol point components being masked for inputting the corrected amplitude value to the power control section 200.

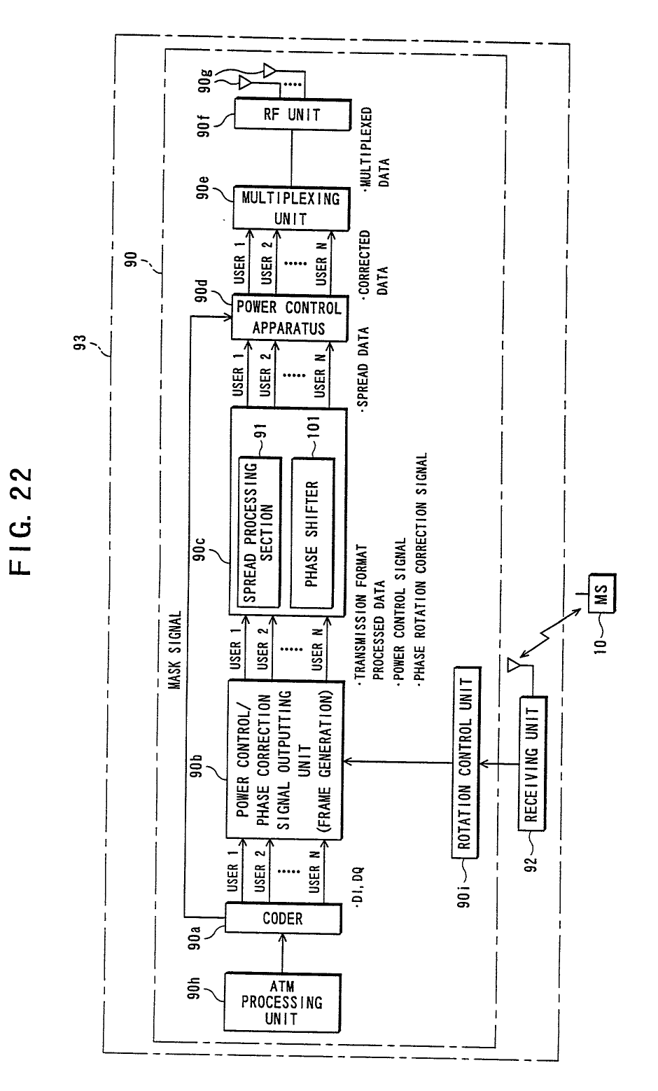

The power control/phase correction signal outputting unit 90b shown in FIGS. 2 and 22 also functions as a frame generating section, so it is expressed as frame generation.

What is claimed is:

1. A power control apparatus comprising:
a power control section for controlling amplitude by correcting a symbol point arrangement of data on the basis of a correction amplitude value inputted from the external and for outputting data to be transmitted, produced by the amplitude control; and
a power correcting section for correcting an amplitude value of a symbol before phase rotation on the basis of a decision signal representative of need/non-need for correction of the symbol amplitude value before the phase rotation and a mask signal indicative of at least one of symbol point components being masked and for inputting the corrected amplitude value to said power control section.

2. A power control apparatus according to claim 1, wherein at least one of said power control section and said power correcting section receive data modulated through the use of a nine-point constellation forming said symbol point arrangement.

3. A power control apparatus according to claim 2, wherein said power correcting section is made to output the corrected amplitude value in units of 45 degree for each symbol.

4. A power control apparatus according to claim 1, wherein said power correcting section includes:
a mask signal correcting section for correcting power control information about transmission on the basis of said mask signal to output the corrected power control information; and
a phase rotation correcting section for correcting the corrected power control information outputted from said mask signal correcting section on the basis of said decision signal and for inputting the corrected amplitude value to said power control section.

5. A power control apparatus according to claim 4, wherein said mask signal correcting section includes:
an arithmetic section for performing predetermined arithmetic processing on said power control information to output the arithmetically processed power control information; and
a selecting section for outputting, as the corrected amplitude value, desired one of said power control information and the arithmetically processed power control information outputted from said arithmetic section.

6. A power control apparatus according to claim 5, wherein said phase rotation correcting section includes:
an arithmetic section for performing predetermined arithmetic processing on the corrected power control information to output the arithmetically processed corrected power control information; and
a selecting section for outputting, as the corrected amplitude value, desired one of the corrected power control information and the arithmetically processed corrected power control information outputted from said arithmetic section on the basis of said decision signal and said mask signal.

7. A power control apparatus according to claim 2, wherein said power correcting section includes:
an arithmetic section for performing predetermined arithmetic processing on said power control information to output the arithmetically processed power control information; and
a selecting section for outputting, as the corrected amplitude value, desired one of said power control information and the arithmetically processed power control information outputted from said arithmetic section on the basis of said decision signal and said mask signal.

8. A power control apparatus according to claim 5, wherein said arithmetic section is designed to output, as the arithmetically processed power control information, subtracted power control information obtained by subtracting a predetermined value from said power control information.

9. A power control apparatus according to claim 5, wherein said arithmetic section is made to output, as the arithmetically processed power control information, added power control information obtained by adding a predetermined value to said power control information.

10. A power control apparatus according to claim 5, further comprising a symbol arrangement information arithmetic section for outputting symbol arrangement information based on logic of said mask signal to said selecting section.

11. A power control apparatus according to claim 1, further comprising a transmission symbol power adjusting section for adjusting transmission symbol power on the basis of the corrected amplitude value outputted from said power correcting section.

12. A power control apparatus comprising:
a power control section for conducting amplitude adjustment by adjusting s symbol point arrangement of data on the basis of an adjustment amplitude value inputted from the external and for outputting data to be transmitted, produced by the amplitude adjustment; and
a power adjusting section for adjusting an amplitude value of a symbol before phase shift on the basis of a decision signal representative of need/non-need for adjustment of the symbol amplitude value before the phase shift and a mask signal representative of a phase shifted position resulting from a symbol point component and for inputting the adjusted amplitude value to said power control section.

13. A power control method comprising:
a phase rotating step of phase-rotating data arranged at a symbol point through the use of a desired modulation method to output data to be transmitted;
a mask signal outputting step of outputting a mask signal representative of which at least one of symbol point components being masked;
an arithmetically processed power control information generating step of conducting predetermined arithmetic processing on power control information about transmission to generate corrected power control information;
selecting/outputting step of selectively outputting desired one of said power control information and the corrected power control information generated in said arithmetically processed power control information generating step on the basis of said mask signal outputted in said mask signal outputting step and a decision signal representative of need/non-need for correction of an amplitude value of a symbol before phase rotation; and
an amplitude controlling step of controlling an amplitude of data to be transmitted, outputted in said phase rotating step, on the basis of said power control information or the corrected power control information selectively outputted in said selecting/outputting step.

14. A power control method according to claim 13, wherein said phase rotating step is made to use a nine-point constellation as the symbol point arrangement.

15. A power control method comprising:
a phase rotating step of phase-rotating data arranged at a symbol point through the use of a desired modulation method to output data to be transmitted;
a corrected power control information outputting step in which a power correcting section having a desired correction quantity for each of said symbol points corrects power control information on the basis of a decision signal representative of need/non-need of an amplitude value of said symbol before phase rotation to output the corrected power control information; and
an amplitude controlling step of controlling an amplitude of data to be transmitted, outputted in said phase rotating step on the basis of the corrected power control information outputted in said corrected power control information outputting step.

16. A power control method comprising:
a constellation correcting step of correcting data placed at each of symbol points through a desired modulation method on the basis of a mask signal representative of at least one of symbol point components being masked, for outputting the corrected data; and
a phase rotation correcting step of correcting the corrected data obtained in said constellation correcting step on the basis of a decision signal representative of need/non-need of an amplitude of said symbol before phase rotation for outputting total corrected data.
